(19) United States
(12) Patent Application Publication
(10) Pub. No.: US 2013/0242491 A1
(43) Pub. Date: Sep. 19, 2013

(54) MODULAR COMPUTER SYSTEMS

(71) Applicants: Steven H. Goldstein, Scottsdale, AZ (US); Kenneth S. Coleman, Mesa, AZ (US)

(72) Inventors: Steven H. Goldstein, Scottsdale, AZ (US); Kenneth S. Coleman, Mesa, AZ (US)

(21) Appl. No.: 13/421,597

(22) Filed: Mar. 15, 2012

(51) Int. Cl. G06F 1/16

(52) U.S. Cl. 361/679.4

(57) ABSTRACT

A module computer system includes a self-contained base module and a self-contained host computer module. The base module incorporates a network of operatively coupled interface connectors including peripheral interface connectors and a module interface connector. The self-contained host computer module is for performing computer functions, and includes a computer interface connector operatively connectable directly to the module interface connector formed in the base module in a computer connecting position of the host computer module for operatively coupling the peripheral interface connectors of the base module to the host computer module for, in turn, operatively coupling the host computer module to computer peripherals coupled to the base module through the peripheral interface connectors of the base module.

### FIELD OF THE INVENTION

The present invention relates to computers.

### BACKGROUND OF THE INVENTION

Early computers arose in the 1970's, and since then the landscape of computing has changed dramatically. Since introduction of early computers, ongoing innovation has led to modern computers that are well-designed and highly integrated, and modern laptops and tablets provide mobility in how users interact with a computer. However, modern computers and mobile computer solutions are so highly integrated that they are difficult and expensive to repair and/or modify as needed, thus necessitating continued improvement in the art.

### SUMMARY OF THE INVENTION

According to the principle of the invention, a module computer system consists of a self-contained base module that includes a network of operatively coupled interface connectors including peripheral interface connectors and a first module interface connector, and a self-contained host computer module for performing computer functions, and which includes a computer interface connector operatively connectable directly to the first module interface connector of the base module in a computer connecting position of the host computer module for operatively coupling the peripheral interface connectors of the base module to the host computer module for, in turn, operatively coupling the host computer module to computer peripherals, such as a keyboard and a monitor, coupled to the base module through the peripheral interface connectors of the base module. The interface connectors of the base module further includes a second module interface connector. A self-contained power module includes a power interface connector operatively connectable directly to the second module interface connector of the base module in a power connecting position of the power module for operatively coupling the network of operatively coupled interface connectors of the base module to receive power from the power module for powering the host computer module in the computer connecting position of the host computer module, and for powering computer peripherals coupled to the base module through the peripheral interface connectors of the base module. In one embodiment, the power module is a power plug module. In another embodiment, the power module is a battery power module. The interface connectors of the base module, the computer interface connector of the host computer module, and the power interface connector of the power module each comply with a USB standard. A base module rail segment is spaced-apart from, and is fixed horizontally to, the base module, a host computer module rail segment is spaced-apart from, and is fixed horizontally to, the host computer module, and in the computer connecting position of the host computer module, the base module rail segment cooperates with the host computer module rail segment to form a peripherals-supporting rail that extends horizontally along the base and host computer modules. A power module rail segment is spaced-apart from, and is fixed horizontally to, the power module, and in the computer connecting position of the host computer module and the power connecting position of the power module, the power module rail segment relates to the base module rail segment so as to form an extension of the peripherals-supporting rail thereby forming a part of the peripherals-supporting rail. In the computer connecting position of the host computer module and the power connecting position of the power module, the base module, the host computer module, and the power module cooperate to form a supporting bottom positionable against a support surface. In the computer connecting position of the host computer module and the power connecting position of the power module, the base module, the host computer module, and the power module cooperate to form opposed, parallel front and rear faces, and the peripheral interface connectors of the base module are formed along, and accessible at, the front and rear faces.

According to the principle of the invention, a module computer system consists of a self-contained base module that includes a network of operatively coupled interface connectors including peripheral interface connectors, and a first module interface connector, a self-contained host computer module for performing computer functions, and a self-contained peripheral module for performing a peripheral function for expanding the computer functions of the host computer module. The peripheral module includes a first computer peripheral interface connector operatively connectable directly to the first module interface connector of the base module in a peripheral connecting position of the peripheral module for operatively coupling the peripheral interface connectors of the base module to the peripheral module for operatively coupling the peripheral module to computer peripherals coupled to the base module through the peripheral interface connectors of the base module, and a second computer peripheral interface connector. The host computer module includes a computer interface connector operatively connectable directly to the second computer peripheral interface connector in a computer connecting position of the host computer module for operatively coupling the host computer module to the peripheral module, and in the peripheral connecting position of the peripheral module for operatively coupling the host computer module to the peripheral interface connectors of the base module for, in turn, operatively coupling the host computer module to computer peripherals coupled to the base module through the peripheral interface connectors of the base module. The interface connectors of the base module further includes a second module interface connector. A self-contained power module includes a power interface connector operatively connectable directly to the second module interface connector of the base module in a power connecting position of the power module for operatively coupling the network of operatively coupled interface connectors of the base module to receive power from the power module for powering the peripheral module in the peripheral connecting position of the peripheral module, for powering the host computer module in the peripheral connecting position of the peripheral module and the computer connecting position of the host computer module, and for powering computer peripherals coupled to the base module through the peripheral interface connectors of the base module. In one embodiment, the power module is a power plug module. In another embodiment, the power module is a battery power module. The interface connectors of the base module, the first and second computer peripheral interface connectors of the peripheral module, the computer interface connector of the host computer module, and the power interface connector of the power module each comply with a USB standard. A base module rail segment is spaced-apart from, and is fixed horizontally to, the base module, a peripheral module rail segment is spaced from, and is fixed horizontally to, the peripheral module, a host computer module rail segment is spaced-apart from, and is fixed horizontally to, the host computer module, and in the peripheral connecting position of the peripheral module and the computer connecting position of the host computer module, the base module rail segment cooperates with the peripheral module rail segment and the host computer module rail segment to form a peripherals-supporting rail that extends horizontally along the base, peripheral, and host computer modules. A power module rail segment is spaced-apart from, and is fixed horizontally to, the power module, and in the peripheral connecting position of the peripheral module, the computer connecting position of the host computer module, and the power connecting position of the power module, the power module rail segment relates to the base module rail segment so as to form an extension of the peripherals-supporting rail thereby forming a part of the peripherals-supporting rail. In the peripheral connecting position of the peripheral module, the computer connecting position of the host computer module, and the power connecting position of the power module, the base module, the peripheral module, the host computer module, and the power module cooperate to form a supporting bottom positionable against a support surface. In the peripheral connecting position of the peripheral module, the computer connecting position of the host computer module, and the power connecting position of the power module, the base module, the peripheral module, the host computer module, and the power module cooperate to form opposed, parallel front and rear faces, wherein the peripheral interface connectors of the base module are formed along, and accessible at, the front and rear faces.

Consistent with the foregoing summary of preferred embodiments, and the ensuing detailed description, which are to be taken together, the invention also contemplates associated apparatus and method embodiments.

### BRIEF DESCRIPTION OF THE DRAWINGS

Referring to the drawings:

FIGS. 1-4 are perspective views of a self-contained base module of a module computer system, the self-contained base module being constructed and arranged in accordance with the principle of the invention;

FIGS. 5-7 are highly generalized schematic representations of the self-contained base module of FIGS. 1-4;

FIGS. 8-11 are perspective views of a self-contained host computer module of a module computer system, the self-contained host computer module being constructed and arranged in accordance with the principle of the invention;

FIGS. 12 and 13 are perspective views of a self-contained power plug module of a module computer system, the self-contained power plug module being constructed and arranged in accordance with the principle of the invention;

FIGS. 14 and 15 are perspective views of a self-contained battery module of a module computer system, the self-contained battery module being constructed and arranged in accordance with the principle of the invention;

FIGS. 16 and 17 are perspective views of a module computer system formed with self-contained base, host computer, and power plug modules, the modular computer system being constructed and arranged in accordance with the principle of the invention;

FIGS. 18 and 19 are perspective views of a module computer system formed with self-contained base, host computer, and battery modules, the modular computer system being constructed and arranged in accordance with the principle of the invention;

FIGS. 20-22 are perspective views of the module computer system of FIGS. 18 and 19 shown as it would appear formed with input and output devices, namely, a keyboard and a separate monitor;

FIGS. 23 and 24 are perspective views of a self-contained peripheral module of a module computer system, the self-contained peripheral module being constructed and arranged in accordance with the principle of the invention;

FIG. 25 is a perspective view of a module computer system formed with self-contained base, host computer, battery, and peripheral modules, the modular computer system being constructed and arranged in accordance with the principle of the invention;

FIGS. 26-29 are perspective views of the module computer system of FIG. 25 shown as it would appear formed with input and output devices, namely, a keyboard and a separate monitor; and

FIGS. 30-33 are perspective views of the module computer system of FIG. 25 shown as it would appear formed with integrated input and output devices, namely, an integrated keyboard and monitor.

### DETAILED DESCRIPTION

Disclosed herein are self-contained computer component modules that are configured to be plugged together in various configurations and are interchangeable for forming module computer systems.

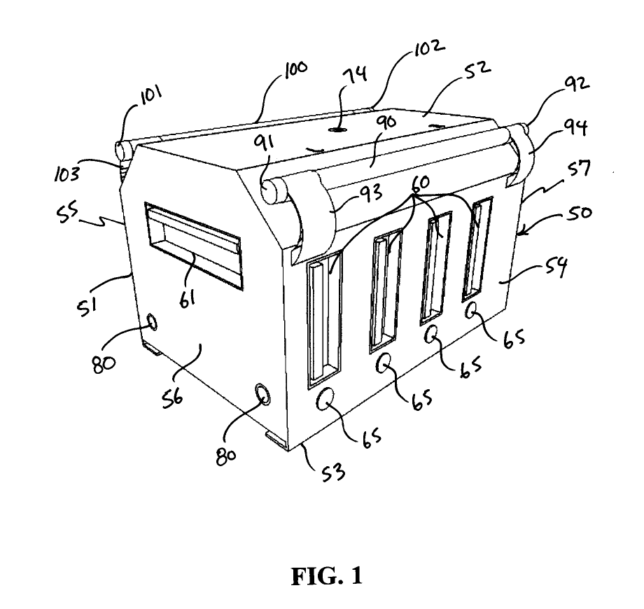

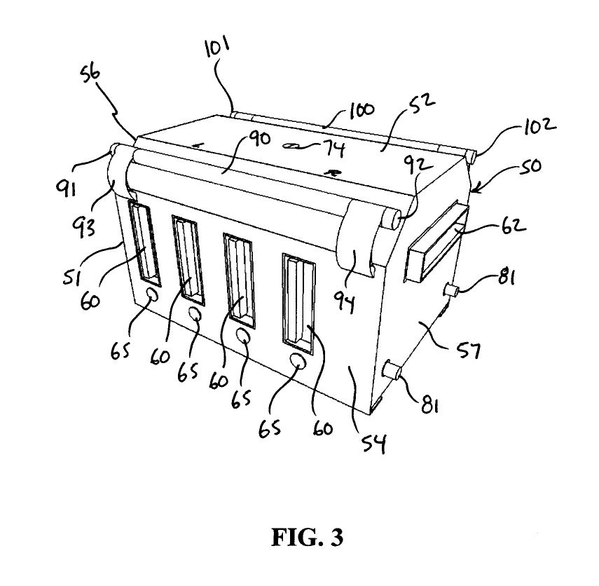

Turning now to the drawings, in which like reference characters indicate corresponding elements throughout the several views, attention is first directed in relevant part to FIGS. 1-4 illustrating perspective views of a self-contained base module 50 of a module computer system, which is operatively connectable to other module or modular components to form modular computer systems, and which is further connectable to computer peripherals, such as input and output devices, for facilitating user interaction with the modular computer systems. Base module 50 is fully self-contained, and includes a housing 51 having opposed horizontal upper and lower ends 52 and 53 and opposed vertical sides 54 and 55 that extend between opposed vertical ends 56 and 57. Upper and lower ends 52 and 53, and sides 54 and 55 cooperate to form the middle of housing 51 of base module 50, and this defined middle extends between opposed ends 56 and 57 of housing 51 of base module 50. Housing 51, and thus base module 50, is compact and in the present embodiment housing 51 is block-shaped being generally rectangular in overall shape in the present embodiment, in which upper end 52 is parallel with respect to lower end 53, side 54 is parallel with respect to side 55, and end 56 is parallel with respect to end 57. Housing 51 is formed of plastic or metal, and upper end 52 forms the top of base module 50, and lower end 53 forms the bottom of base module 50.

Base module 50 is formed with a network of operatively coupled interface connectors that are supported by housing 51 and which are used to operatively connect corresponding module components and computer peripherals. The network of operatively coupled interface connectors includes component or peripheral interface connectors 60, and module interface connectors 61 and 62. Module interface connectors 61 and 62 are used to operatively couple module components of a module computer system according to the invention, and peripheral interface connectors 60 are used to operatively couple computer peripherals to base module 50 and, thus, to a module computer system incorporating base module 50.

Module interface connector 61 is formed in end 56 of housing 51 and is exposed at end 56 so as to be available for use, and module interface connector 62 is formed in end 57 of housing 51 and is exposed at end 57 so as to be available for use. Component interface connectors 60 are formed in the middle of housing 51 and are exposed so as to be available for use. More specifically, component interface connectors 60 are formed in sides 54 and 55 of housing 51. In the present embodiment, there are a total of eight component interface connectors 60, including four interface connectors 60 formed in side 54 of housing 51 and four interface connectors 60 formed in side 55 of housing 51. According to a preferred embodiment, interface connectors 60, 61, and 62 each comply with a Universal Serial Bus (USB) standard and, as such, are each standard USB interface connectors that are well known in the art. Interface connectors 60, 61, 62 are preferably conventional USB 3.0 interface connectors for providing high transfer rates. In alternate embodiments, interface connectors 60, 61, and 62 are USB 2.0 interface connectors. In a further embodiment, a combination of USB 2.0 and 3.0 interface connectors are used for interface connectors 60, 61, and 62. As a matter of a specific configuration of USB 2.0 and 3.0 interface connectors in a particular embodiment, module interface connectors 61 and 62 comply with USB 3.0, four of the eight peripheral interface connectors 60 formed in the middle of base module 50 comply with USB 2.0, and the remaining four of the eight peripheral interface connectors 60 formed in the middle of base module 50 comply with USB 2.0. In this latter embodiment, peripheral interface connectors 60 formed in each of sides 54 and 55 of base module 50 include two peripheral interface connectors 60 that comply with USB 2.0 and two peripheral interface connectors 60 that that comply with USB 3.0. In base module 50, peripheral interface connectors 60 are conventional female USB interface connectors that conventionally accept corresponding male USB interface connectors/plugs, module interface connector 61 is a conventional female USB interface connector that conventionally accepts a corresponding male USB interface connector/plug, and module interface connector 62 is a conventional male USB interface connector/plug that is conventionally received by a corresponding female USB interface connector. Peripheral interface connectors 60 are each associated with a corresponding light 65, which illuminate in response to receiving and sensing a corresponding male USB interface connector/plug, and which do not illuminate when unplugged from a corresponding male USB connector/plug. Lights 65 are each a conventional LED, which are operatively connected to peripheral interface connectors 60 with conventional electrical circuitry (not shown).

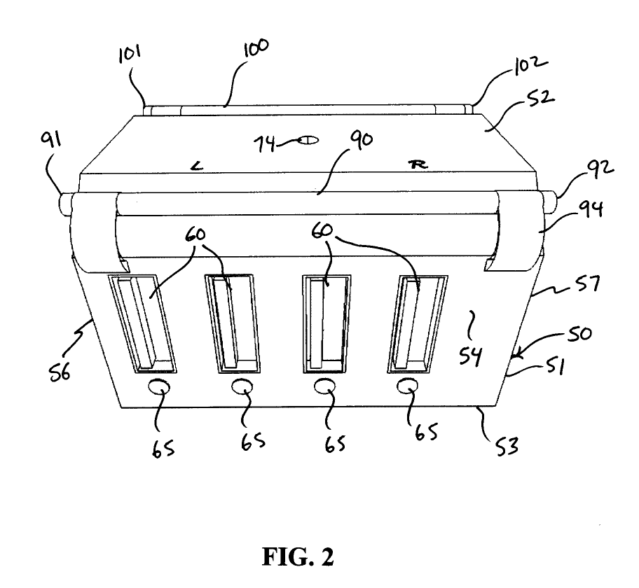

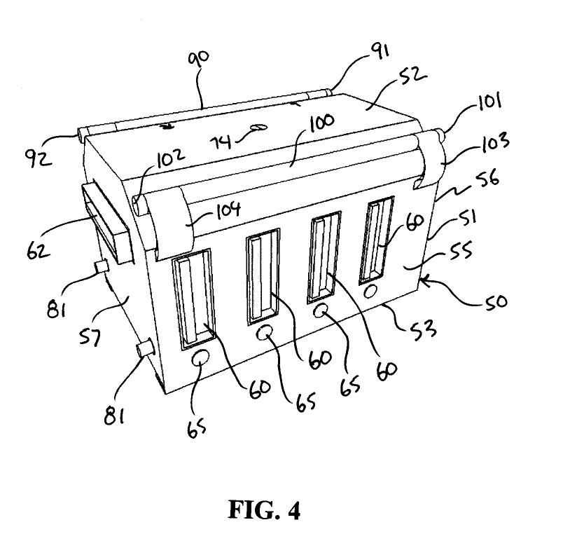

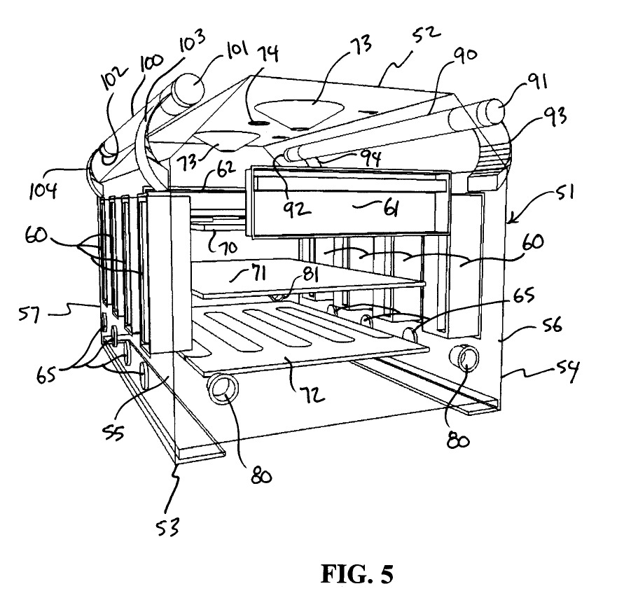

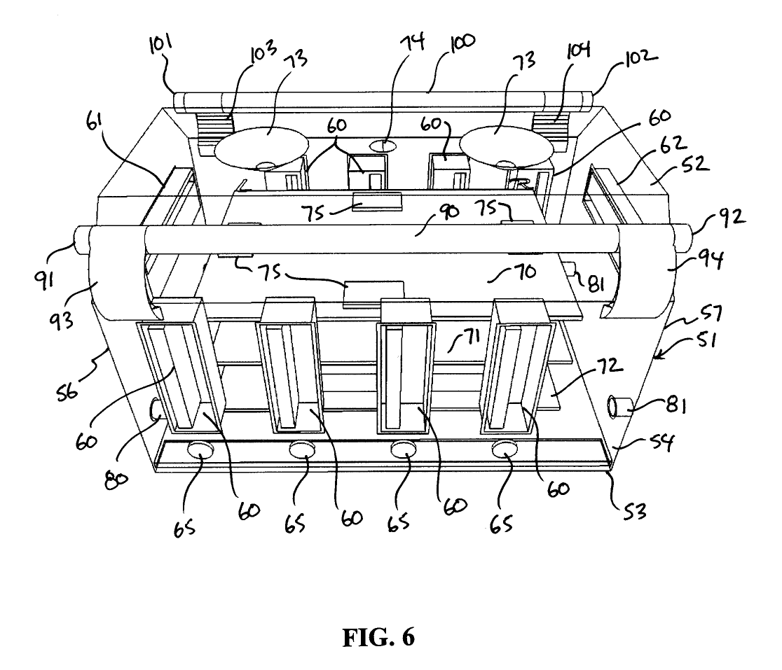

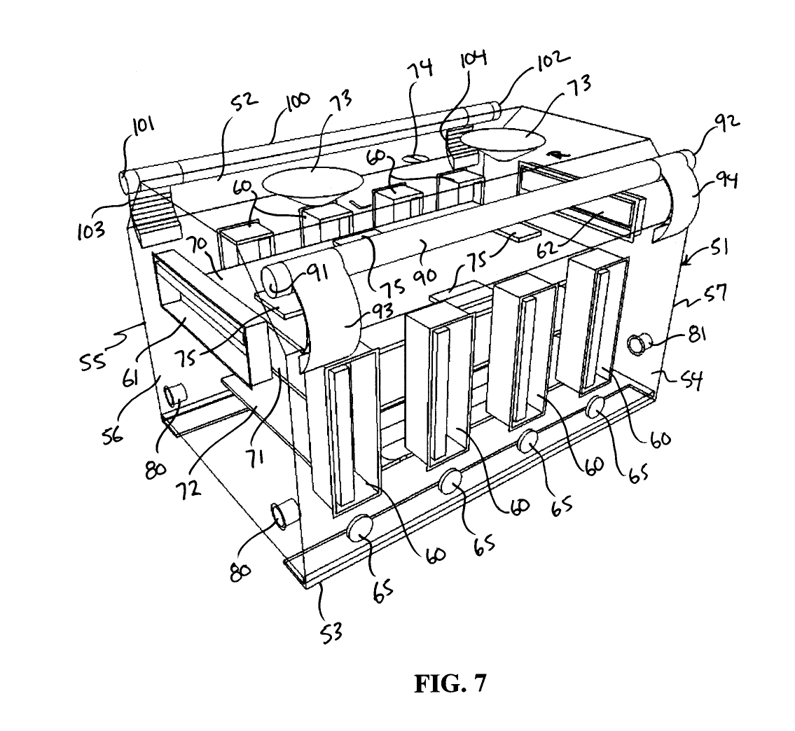

Looking to FIGS. 5-7, which are highly generalized schematic representations of base module 50, base module 50 incorporates a conventional printed circuit board (PCB) 70, a conventional anti-static pad 71 for absorbing/dissipating built-up static electricity, a conventional and standard wireless network antenna 72, conventional staticspeakers 73 for issuing aural stimuli, and a conventional microphone 74, all of which are formed in and supported by housing 51 and which are electrically and operatively interconnected with conventional electrical circuitry (not shown). Staticspeakers 73 and microphone 74 are formed at upper end 52 of housing 51 in the present embodiment, and they can be formed at other locations along housing 51 if so desired. PCB 70 supports conventional USB host controllers 75, and interface connectors 60, 61, and 62 are conventionally operatively connected or linked through host controllers 75 with conventional electrical circuitry (not shown). Because interface connectors 60, 61, and 62 comply with a USB standard, host controllers 75 also comply with the corresponding USB standard and this is a conventional and well-known arrangement. Wireless network antenna 72 is operatively coupled to interface connectors 60, 61, and 62 through PCB 70 with conventional electrical circuitry for providing wireless connectivity to networked components through interface connectors 60, 61, and 62. In the present embodiment, wireless network antenna 72 is electrically and operatively connected to contact structures formed in base module 50 with conventional electrical circuitry (not shown), including one contact structure formed in end 56 of housing 51, and another contract structure is formed in end 57 of housing 51. The contact structure formed in end 56 consists of opposed female contacts 80, and the contract structure formed in end 57 consists of opposed male contacts 81. FIG. 1 shows female contacts 80 formed in end 56 of housing 51, and FIGS. 2 and 4 show male contacts 81 formed in end 57 of housing 51. The female and male contacts 80 and 81 are fashioned of metal, such as nickel and/or aluminum.

Referencing FIGS. 1-7 in relevant part, base module 50 is formed with opposed rail segments 90 and 100, which are used to receive and support computer peripherals, such as input and output devices. Rail segment 90 is formed exteriorly of housing 51 alongside of side 54 of housing 51, and rail segment 100 is formed exteriorly of housing 51 alongside of side 55 of housing 51. Rail segment 90 and 100 are elongate and are equal in size and shape. Rail segment 90 has opposed free ends 91 and 92, and is spaced-apart from, and is fixed horizontally to, side 54 of housing 51 of base module 50 near upper end 52 of housing 51 with opposed struts 93 and 94 attached between side 54 of housing 51 and rail segment 90. Rail segment 90 extends horizontally alongside of side 54 of housing 51 of base module 50 from free end 91 of rail segment 90 near end 56 of housing 51 to free end 92 of rail segment 90 near end 57 of housing 51. Rail segment 100 has opposed free ends 101 and 102, and is spaced-apart from, and is fixed horizontally to, side 55 of housing 51 of base module 50 near upper end 52 of housing 51 with opposed struts 103 and 104 attached between side 55 of housing 51 and rail segment 100. Rail segment 100 extends horizontally alongside of side 55 of housing 51 of base module 50 from free end 101 of rail segment 90 near end 56 of housing 51 to free end 102 of rail segment 100 near end 57 of housing 51. Rail segments 90 and 100 oppose one another on either side of housing 51 of base module 50, and are parallel with respect to each other.

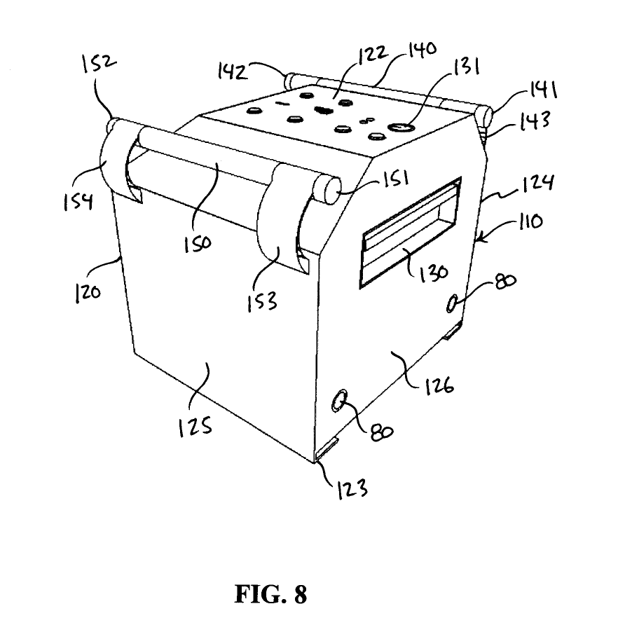

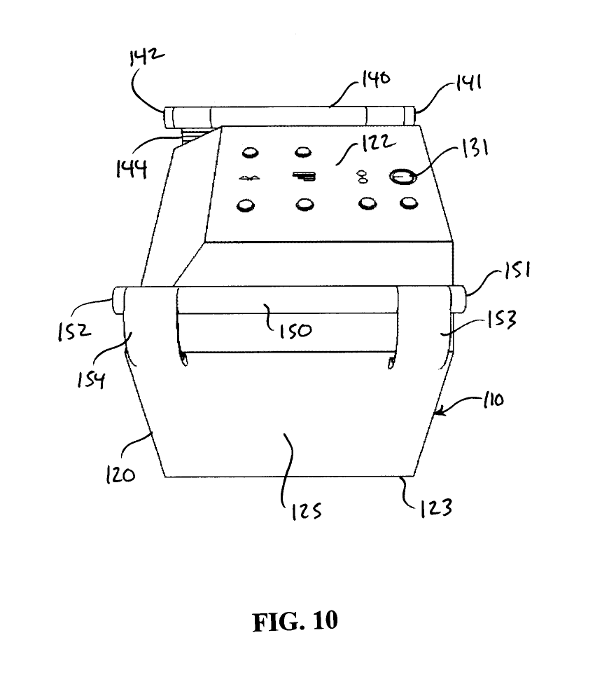

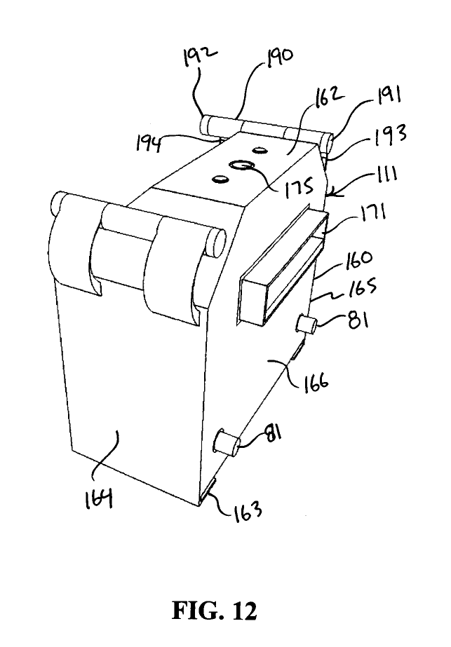

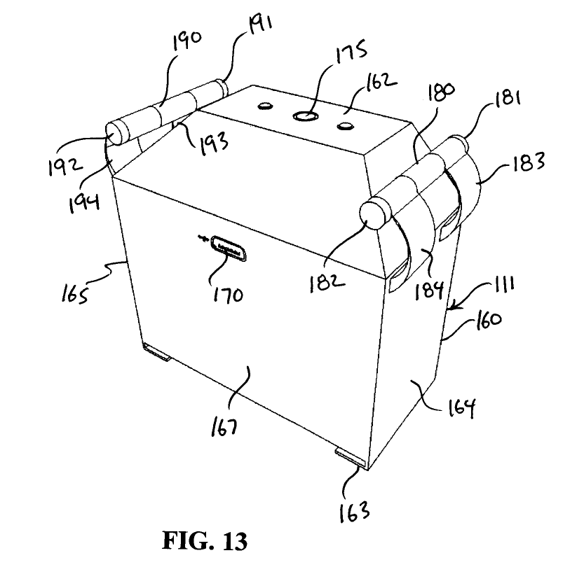

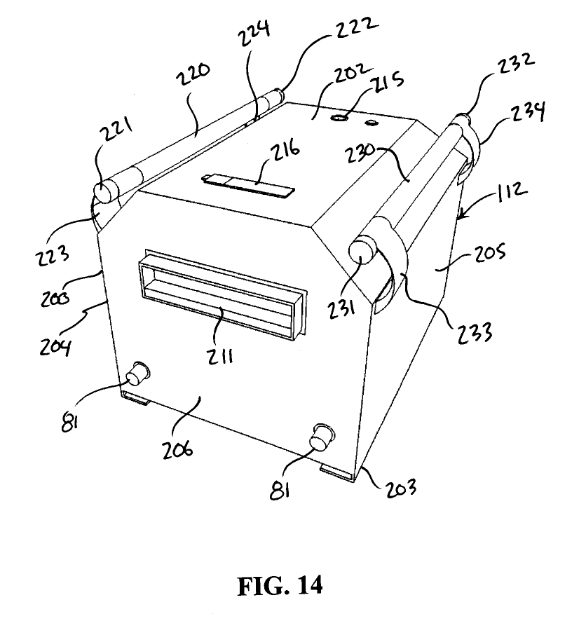

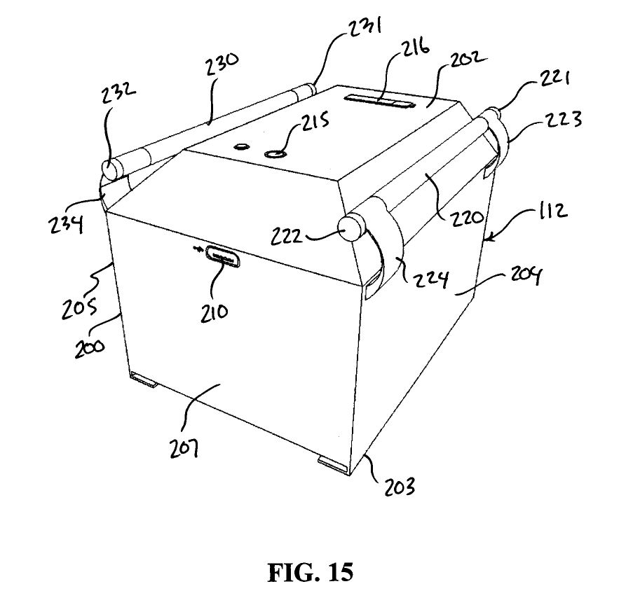

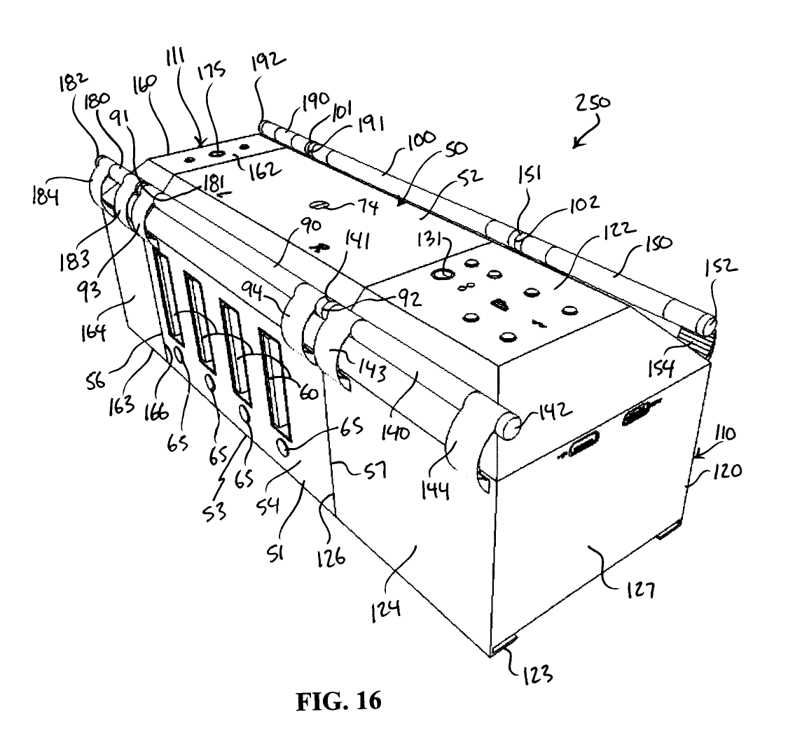

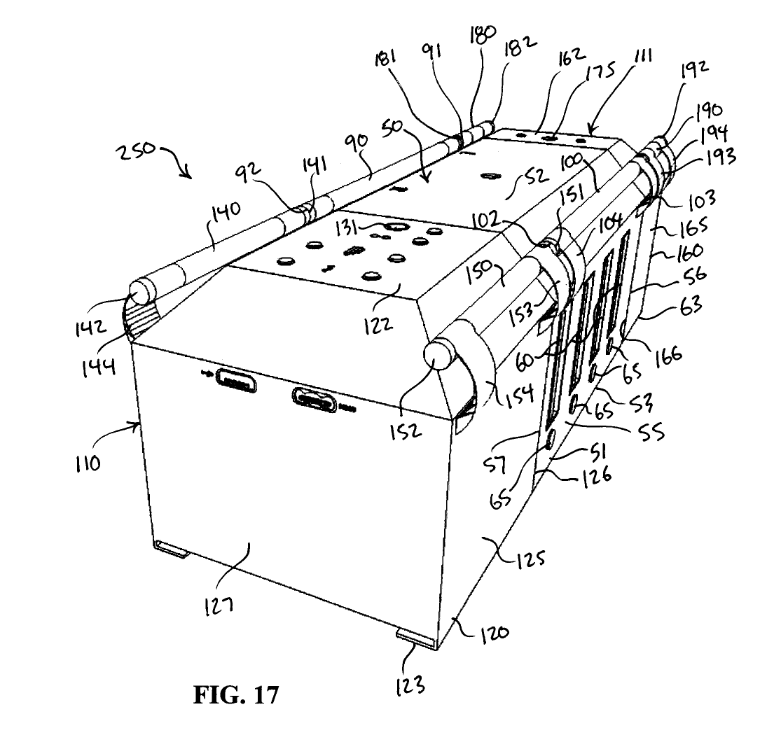

Base module 50 is used with other modular components to form modular computer systems, including a self-contained host computer module 110 shown in FIGS. 8-11, power modules including a self-contained power plug module 111, shown in FIGS. 12 and 13, and a self-contained battery module 112, shown in FIGS. 14 and 15, and a self-contained peripheral module 113 shown in FIGS. 16 and 17. The various modules are compact, easy to transport and highly mobile, and may be individually replaced, repaired, or upgraded as needed.

Referencing FIGS. 8-11 in relevant part, host computer module 110 is constructed and arranged to perform computer functions, and is fully self-contained. Computer module 110 includes a housing 121 having opposed horizontal upper and lower ends 122 and 123 and opposed vertical sides 124 and 125 that extend between opposed vertical ends 126 and 127. Upper and lower ends 122 and 123, and sides 124 and 125 cooperate to form the middle of housing 121 of host computer module 110, and this defined middle extends between opposed ends 126 and 127 of housing 121 of host computer module 110. Housing 121, and thus host computer module 110, is compact and in the present embodiment housing 121 is block-shaped being generally square in overall shape in the present embodiment, in which upper end 122 is parallel with respect to lower end 123, side 124 is parallel with respect to side 125, and end 126 is parallel with respect to end 127. Housing 51 is formed of plastic or metal, and upper end 122 forms the top of host computer module 110, and lower end 123 forms the bottom of host computer module 110.

Housing 120 contains a conventional computer architecture or system for performing conventional computer functions, which is operatively coupled to a computer interface connector 130, which is supported by housing 120 and which is used to operatively connect host computer module 110 to corresponding module components and computer peripherals. Computer interface connector 130 is formed in end 126 of housing 120 and is exposed at end 126 so as to be available for use. According to a preferred embodiment, computer interface connector 130 complies with a USB standard and, as such, is a standard USB interface connector well known in the art. Computer interface connector 130 is preferably a conventional USB 3.0 interface connector for providing high transfer rates, and in an alternate embodiment it may be formed as a conventional USB 2.0 interface connector. In the present embodiment, computer interface connector 130 is a conventional female USB interface connector that conventionally accepts a corresponding male USB interface connectors/plugs, including male module interface connector 62 of base module 50 in a computer connecting position of host computer module 110 relative to base module 50, shown for example in FIG. 16, for operatively connecting host computer module 110 to base module 50 and, more specifically, for operatively coupling host computer module 110 to module interface connector 61 of base module for, in turn, operatively coupling host computer module 110 to module components coupled to base module 50 at module interface connector 61, and to peripheral interface connectors 60 of base module 50 for, in turn, operatively coupling host computer module 110 to computer peripherals coupled to base module 50 through peripheral interface connectors 60 of base module. In the computer connecting position of host computer module 110 to base module 50 operatively connecting host computer module 110 to base module 50, host computer module 110 is plugged into base module 50 by plugging computer interface connector 130 of host computer module 110 into module interface connector 62 of base module 50, and further details of this are discussed more fully below.

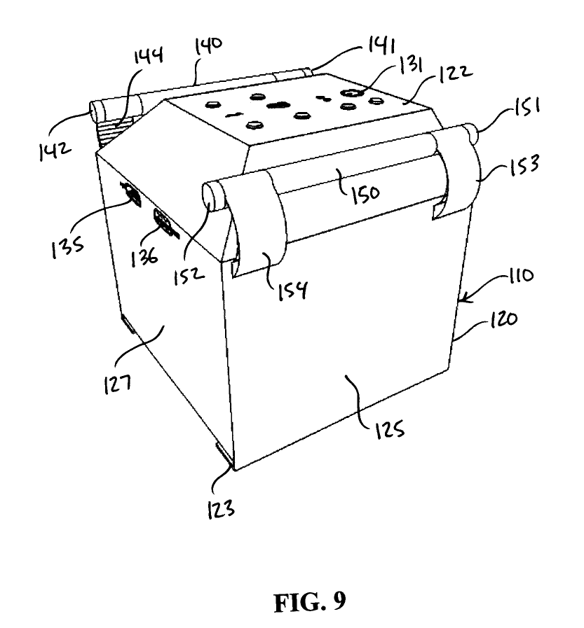

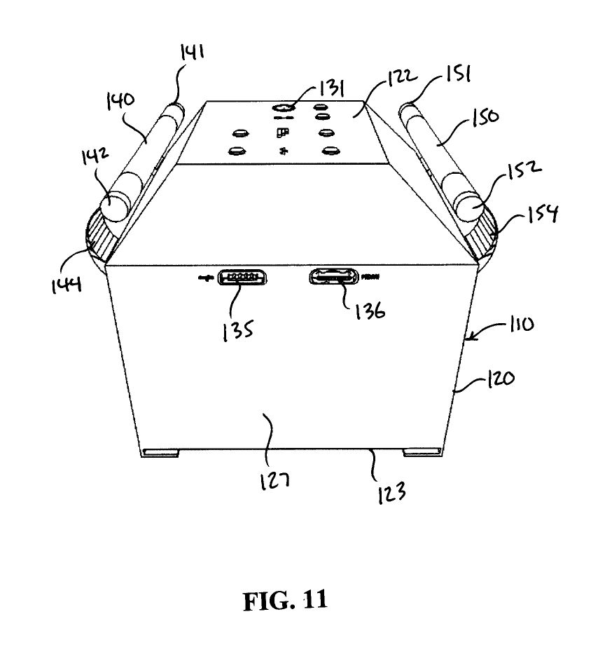

The computer architecture or system formed in housing 120 of host computer module 110 is entirely conventional and itself does not form part of the invention. As a matter of example, the computer system formed in host computer module 110 includes conventional computer components including, for instance, a central processor, standard memory, and flash memory maintaining an operating system or platform, a standard wireless network chip for facilitating wireless access to networked components, a Bluetooth transceiver/receiver, a conventional or standard wireless network antenna just like that of antenna 72 of base module 50, and the like. In the present embodiment, the wireless network antenna of host computer module 110 is electrically and operatively connected to a contact structure formed in host computer module 110 with conventional electrical circuitry. The contact structure of host computer module 110 is formed in end 126 of housing 120 of host computer module 110, and consists of opposed female contacts 80. Female contacts 80 correspond and relate to male contacts 81 formed in end 57 of base module 50, and receive and contact male contacts 81 in the computer connecting position of host computer module 110 to base module 50 for operatively connecting antenna 72 of base module 50 to the antenna of host computer module 110 for providing antenna amplification for amplified wireless connectivity to networked components, such as to amplify wireless, Bluetooth, and any other peripheral requiring connectivity. Host computer module 110 is also formed with a conventional ON/OFF switch 131, which is formed at upper end 122 of housing 120, for turning host computer module ON and OFF. As seen in FIGS. 9 and 11, host computer module 110 is additionally formed with opposed conventional D USB connectors/outlets, including one D USB connector 135 for receiving a corresponding plug to power host computer module 110, and a micro- or mini-HD connector 136 for receiving a corresponding plug for applying audio/video signals to host computer module 110.

With continuing reference to FIGS. 8-11 in relevant part, host computer module 110 is formed with opposed rail segments 140 and 150, which are used to receive and support computer peripherals, such as input and output devices. Rail segment 140 is formed exteriorly of housing 120 alongside of side 124 of housing 120, and rail segment 150 is formed exteriorly of housing 120 alongside of side 125 of housing 120. Rail segment 140 and 150 are elongate and are equal in size and shape. Rail segment 140 has opposed free ends 141 and 142, and is spaced-apart from, and is fixed horizontally to, side 124 of housing 120 of host computer module 110 near upper end 122 of housing 120 with opposed struts 143 and 144 attached between side 124 of housing 120 and rail segment 140. Rail segment 140 extends horizontally alongside of side 124 of housing 120 of host computer module 110 from free end 141 of rail segment 140 near end 126 of housing 120 to free end 142 of rail segment 140 near end 127 of housing 120. Rail segment 150 has opposed free ends 151 and 152, and is spaced-apart from, and is fixed horizontally to, side 125 of housing 120 of host computer module 110 near upper end 122 of housing 120 with opposed struts 153 and 154 attached between side 125 of housing 120 and rail segment 150. Rail segment 150 extends horizontally alongside of side 125 of housing 120 of host computer module 110 from free end 151 of rail segment 140 near end 126 of housing 120 to free end 152 of rail segment 150 near end 127 of housing 120. Rail segments 140 and 150 oppose one another on either side of housing 120 of host computer module 110, and are parallel with respect to each other.

Referring now and in relevant part to FIGS. 12 and 13, a first embodiment of a power module is illustrated, which is a power plug module 111 used to provide power to base module 50 and to host computer module 110 in the computer connecting position of host computer module 110 when power plug module 111 is operatively connected to base module 50 and to a dedicated power source, such as conventional power outlet. Power plug module 111 is fully self-contained, and includes a housing 161 having opposed horizontal upper and lower ends 162 and 163 and opposed vertical sides 164 and 165 that extend between opposed vertical ends 166 and 167. Upper and lower ends 162 and 163, and sides 164 and 165 cooperate to form the middle of housing 161 of power plug module 111, and this defined middle extends between opposed ends 166 and 167 of housing 161 of power plug module 111. Housing 161, and thus power plug module 111, is compact and block-shaped and in the present embodiment housing 161 is generally square in overall shape, in which upper end 162 is parallel with respect to lower end 163, side 164 is parallel with respect to side 165, and end 166 is parallel with respect to end 167. Housing 160 is formed of plastic or metal, and upper end 162 forms the top of power plug module 111, and lower end 163 forms the bottom of power plug module 111.

Power plug module 111 is formed with power a connector/outlet 170 and a power interface connector 171, which are operatively coupled in power communication with conventional power circuitry formed in housing 160, and which is constructed and arranged to transfer electrical power from power connector 170 to power interface connector 171 for power supply purposes. Power connector 170 is formed in end 167 of housing 160 of power plug module 111, is exposed at end 167 of housing 160 so as to be available for use, and is a conventional D USB connector/outlet for receiving a corresponding plug of a conventional power cord to supply power to power plug module 111. Power interface connector 171 is formed in end 166 of housing 160 of power plug module 111, and is used to operatively or power connect power plug module 111 to corresponding module components and computer peripherals. Power interface connector 171 is exposed at end 166 of housing 160 of power plug module 111 so as to be available for use. According to a preferred embodiment, power interface connector 171 complies with a USB standard and, as such, is a standard USB interface connector well known in the art. Power interface connector 171 is preferably a conventional USB 3.0 interface connector, and in an alternate embodiment it may be formed as a conventional USB 2.0 interface connector. In the present embodiment, power interface connector 171 is a conventional male USB interface connector/plug that is conventionally received by a corresponding female USB interface connectors, including female module interface connector 61 of base module 50 in a power connecting position of power plug module 111 relative to base module 50, shown for example in FIG. 16, for operatively or power connecting power plug module 111 to base module 50 for powering base module 50 and for powering other modules and computer peripherals operatively connected to base module 50. More specifically, in the power connecting position of power plug module 111, power plug module 111 is coupled to base module 50 for operatively coupling the network of operatively coupled interface connectors 60, 61, and 62 of base module 50 to receive power from power plug module 111 for powering host computer module 110 in the computer connecting position of host computer module 110, and for powering computer peripherals coupled to base module 50 through peripheral interface connectors 60 of base module 50. In the power connecting position of power plug module 111 to base module 50 operatively connecting power plug module 111 to base module 50, it is to be understood that power plug module 111 is plugged into base module 50 by plugging power interface connector 171 of power plug module 111 into module interface connector 61 of base module 50, and further details of this are discussed more fully below.

The power circuitry formed in housing 160 of power plug module 111 between power connector 170 and power interface connector 171 is entirely conventional and itself does not form part of the invention. Like base module 50 and host computer module 110, power plug module 111 incorporates a conventional or standard wireless network antenna inside housing 160 just like that of antenna 72 of base module 50, and like the similar antenna formed in host computer module 110. In the present embodiment, the wireless network antenna of power plug module 111 is electrically and operatively connected to a contact structure formed in power plug module 111 with conventional electrical circuitry. The contact structure of power plug module 111 is formed in end 166 of housing 160 of power plug module 111, and consists of opposed male contacts 81. Male contacts 81 correspond and relate to female contacts 80 formed in end 56 of base module 50, and receive in contact female contacts 80 in the power connecting position of power plug module 111 to base module 50 for operatively connecting antenna 72 of base module 50 to the antenna of power plug module 111 for providing antenna amplification for amplified wireless connectivity to networked components, such as to amplify wireless and Bluetooth connectivity to networked components. Power plug module 111 is also formed with a conventional ON/OFF switch 175, which is formed at upper end 162 of housing 160, for turning power plug module 111 ON and OFF.

With continuing reference to FIGS. 12 and 13 in relevant part, power plug module 111 is formed with opposed rail segments 180 and 190, which are used to receive and support computer peripherals, such as input and output devices. Rail segment 180 is formed exteriorly of housing 160 alongside of side 164 of housing 160, and rail segment 190 is formed exteriorly of housing 160 alongside of side 165 of housing 160. Rail segment 180 and 190 are elongate and are equal in size and shape. Rail segment 180 has opposed free ends 181 and 182, and is spaced-apart from, and is fixed horizontally to, side 164 of housing 160 of power plug module 111 near upper end 162 of housing 160 with opposed struts 183 and 184 attached between side 164 of housing 160 and rail segment 180. Rail segment 180 extends horizontally alongside of side 164 of housing 160 of power plug module 111 from free end 181 of rail segment 180 near end 166 of housing 160 to free end 182 of rail segment 180 near end 167 of housing 160. Rail segment 190 has opposed free ends 191 and 192, and is spaced-apart from, and is fixed horizontally to, side 165 of housing 160 of power plug module 111 near upper end 162 of housing 160 with opposed struts 193 and 194 attached between side 165 of housing 160 and rail segment 190. Rail segment 190 extends horizontally alongside of side 165 of housing 160 of power plug module 111 from free end 191 of rail segment 180 near end 166 of housing 160 to free end 192 of rail segment 190 near end 177 of housing 160. Rail segments 180 and 190 oppose one another on either side of housing 160 of power plug module 111, and are parallel with respect to each other.

And now referring in relevant part to FIGS. 14 and 15, an alternate embodiment of a power module is illustrated, which is battery module 111 used to provide battery power to base module 50 and to host computer module 110 in the computer connecting position of host computer module 110 when battery module 112 is operatively connected to base module 50. Battery module 112 is fully self-contained, and includes a housing 201 having opposed horizontal upper and lower ends 202 and 203 and opposed vertical sides 204 and 205 that extend between opposed vertical ends 206 and 207. Upper and lower ends 202 and 203, and sides 204 and 205 cooperate to form the middle of housing 201 of battery module 112, and this defined middle extends between opposed ends 206 and 207 of housing 201 of battery module 112. Housing 201, and thus battery module 112, is compact and block-shaped and in the present embodiment housing 201 is generally rectangular in overall shape, in which upper end 202 is parallel with respect to lower end 203, side 204 is parallel with respect to side 205, and end 206 is parallel with respect to end 207. Housing 200 is formed of plastic and/or metal, and upper end 202 forms the top of battery module 112, and lower end 203 forms the bottom of battery module 112.

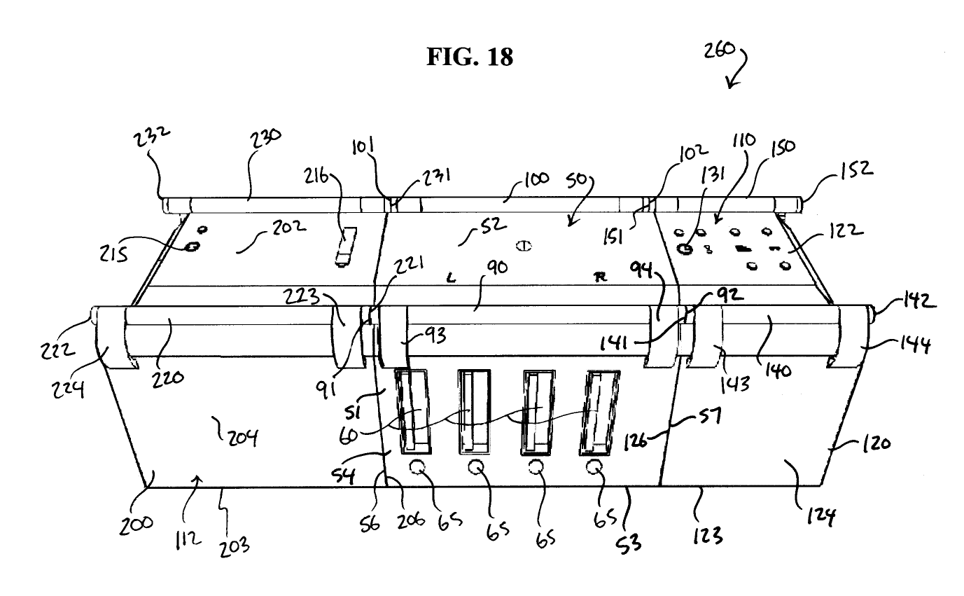

Battery module 112 is formed with a power connector/outlet 210 and a battery interface connector 211, which are operatively coupled in power communication with conventional battery power circuitry and a battery formed in housing 200. The battery power circuitry is well known, and is constructed and arranged to transfer electrical battery power from power connector 210 to battery interface connector 211 for battery power supply purposes. The battery of battery module 112 is a conventional and well known battery form, such as a conventional and rechargeable lithium-ion battery. Although battery module 112 incorporates one battery, it may include two or more such battery for prolonged battery power capability and redundancy. Power connector 210 is formed in end 207 of housing 200 of battery module 112, is exposed at end 207 of housing 200 so as to be available for use, and is a conventional D USB connector/outlet for receiving a corresponding plug of a conventional power cord to supply power to battery module 112 for recharging the battery of battery module 112. Battery interface connector 211 is formed in end 206 of housing 200 of battery module 112, and is used to operatively or power connect battery module 112 to corresponding module components and computer peripherals. Battery interface connector 211 is exposed at end 206 of housing 200 of battery module 112 so as to be available for use. According to a preferred embodiment, battery interface connector 211 complies with a USB standard and, as such, is a standard USB interface connector well known in the art. Battery interface connector 211 is preferably a conventional USB 3.0 interface connector, and in an alternate embodiment it may be formed as a conventional USB 2.0 interface connector. In the present embodiment, battery interface connector 211 is a conventional male USB interface connector/plug that is conventionally received by a corresponding female USB interface connectors, including female module interface connector 61 of base module 50 in a battery power connecting position of battery module 112 relative to base module 50, shown for example in FIG. 18, for operatively or battery power connecting battery module 112 to base module 50 for battery powering base module 50 and for powering other modules and computer peripherals operatively connected to base module 50. More specifically, in the battery power connecting position of battery module 112, battery module 112 is coupled to base module 50 for operatively coupling the network of operatively coupled interface connectors 60, 61, and 62 of base module 50 to receive battery power from battery module 112 for powering host computer module 110 in the computer connecting position of host computer module 110, and for battery powering computer peripherals coupled to base module 50 through peripheral interface connectors 60 of base module 50. In the battery power connecting position of battery module 112 to base module 50 operatively connecting battery module 112 to base module 50, it is to be understood that battery module 112 is plugged into base module 50 by plugging battery interface connector 211 of battery module 112 into module interface connector 61 of base module 50, and further details of this are discussed more fully below.

The battery and the battery power circuitry formed in housing 200 of battery module 112 between power connector 210 and battery interface connector 211 are entirely conventional and each do not form part of the invention Like base module 50 and host computer module 110, battery module 112 incorporates a conventional or standard wireless network antenna inside housing 200 just like that of antenna 72 of base module 50, and like the similar antenna formed in host computer module 110. In the present embodiment, the wireless network antenna of battery module 112 is electrically and operatively connected to a contact structure formed in battery module 112 with conventional electrical circuitry. The contact structure of battery module 112 is formed in end 206 of housing 200 of battery module 112, and consists of opposed male contacts 81. Male contacts 81 correspond and relate to female contacts 80 formed in end 56 of base module 50, and receive in contact female contacts 80 in the power connecting position of battery module 112 to base module 50 for operatively connecting antenna 72 of base module 50 to the antenna of battery module 112 for providing antenna amplification for amplified wireless connectivity to networked components. Battery module 112 may be formed with a conventional ON/OFF switch 215 for turning battery module 112 ON and OFF, and a power indicator light 216 for indicating the power level of the battery of battery module 112, both of which are formed at upper end 202 of housing 200.

With continuing reference to FIGS. 14 and 15 in relevant part, battery module 112 is formed with opposed rail segments 220 and 230, which are used to receive and support computer peripherals, such as input and output devices. Rail segment 220 is formed exteriorly of housing 200 alongside of side 204 of housing 200, and rail segment 230 is formed exteriorly of housing 200 alongside of side 205 of housing 200. Rail segment 220 and 230 are elongate and are equal in size and shape. Rail segment 220 has opposed free ends 221 and 222, and is spaced-apart from, and is fixed horizontally to, side 204 of housing 200 of battery module 112 near upper end 202 of housing 200 with opposed struts 223 and 224 attached between side 204 of housing 200 and rail segment 220. Rail segment 220 extends horizontally alongside of side 204 of housing 200 of battery module 112 from free end 221 of rail segment 220 near end 206 of housing 200 to free end 222 of rail segment 220 near end 207 of housing 200. Rail segment 230 has opposed free ends 231 and 232, and is spaced-apart from, and is fixed horizontally to, side 205 of housing 200 of battery module 112 near upper end 202 of housing 200 with opposed struts 233 and 234 attached between side 205 of housing 200 and rail segment 230. Rail segment 230 extends horizontally alongside of side 205 of housing 200 of battery module 112 from free end 231 of rail segment 220 near end 206 of housing 200 to free end 232 of rail segment 230 near end 177 of housing 200. Rail segments 220 and 230 oppose one another on either side of housing 200 of battery module 112, and are parallel with respect to each other.

Host computer module 110 and power plug module 111 may be plugged into base module 50 to form a module computer system, and host computer module 110 and battery module 112 may be plugged into base module to form an alternate embodiment of a module computer system. FIGS. 16 and 17 are perspective views of a module computer system 250 formed with host computer module 110 and power plug module 111 plugged into base module 50. To form module computer system 250, host computer module 110 and power plug module 111 are plugged into base module 50 so as to operatively connect host computer module 110 and power plug module 111 to base module 50. To plug host computer module 110 into base module 50 in a computer connecting position of host computer module 110 relative to base module 50, both are positioned upright next to each other from bottom to top and end 126 of host computer module 110 formed with computer interface connector 130 and female contacts 80 is directed toward end 57 of base module 50 formed with module interface connector 62 and male contacts 81 so as to register computer interface connector 130 and female contacts 80 formed in end 126 of host computer module 110 with module interface connector 62 and male contacts 81, respectively, formed in end 57 of base module 50. At this point, base module 50 and host computer module 110 are simply pushed together plugging module interface connector 62 of base module 50 into computer interface connector 130 of host computer module 110 and plugging male contacts 81 of base module 50 into female contacts 80 of host computer module 110. By so plugging host computer module 110 to base module 50 in the computer connecting position of host computer module 110 relative to base module 50 as shown in FIGS. 16 and 17, end 126 of host computer module 110 directly contacts end 57 of base module 50, host computer module 110 is operatively coupled or otherwise connected to base module 50 at module interface connector 62 thereby operatively coupling host computer module 110 to peripheral interface connectors 60 of base module 50 for, in turn, operatively coupling host computer module 110 to computer peripherals coupled to base module 50 through peripheral interface connectors 60 of base module 50, and male contacts 81 formed in end 57 of base module 50 contact corresponding female contacts 80 formed in end 126 of host computer module 110 operatively connecting antenna 72 of base module 50 to the corresponding antenna of host computer module 110 for providing antenna amplification for amplified wireless connectivity to networked components, such as to amplify wireless, Bluetooth, and any other peripheral requiring connectivity.

To plug power plug module 111 into base module 50 in a power connecting position of power plug module 111 relative to base module 50 to power base module 50 and also host computer module 110 in the computer connecting position of host computer module 110, both are positioned upright next to each other from bottom to top and end 166 of power plug module 111 formed with power interface connector 171 and male contacts 81 is directed toward end 56 of base module 50 formed with module interface connector 61 and female contacts 80 so as to register power interface connector 171 and male contacts 81 formed in end 166 of power plug module 111 with module interface connector 61 and female contacts 80, respectively, formed in end 56 of base module 50. At this point, base module 50 and power plug module 111 are simply pushed together plugging power interface connector 171 of power plug module 111 into module interface connector 61 of base module 50 and plugging male contacts 81 of power plug module 111 into female contacts 80 of base module 50. By so plugging power plug module 111 to base module 50 in the power connecting position of power plug module 111 relative to base module 50 as shown in FIGS. 16 and 17, end 166 of power plug module 111 directly contacts end 56 of base module 50, power plug module 111 is operatively coupled or otherwise connected to base module 50 at module interface connector 61 thereby operatively coupling the network of operatively coupled interface connectors 60, 61, and 62 of base module 50 to receive power from power plug module 111 for powering host computer module 110 in the computer connecting position of host computer module 110, and for powering computer peripherals coupled to base module 50 through peripheral interface connectors 60 of base module 50, and male contacts 81 formed in end 66 of power plug module 111 contact corresponding female contacts 80 formed in end 56 of base module 50 operatively connecting antenna 72 of base module 50 to the corresponding antenna of power plug module 111 for providing antenna amplification for amplified wireless connectivity to networked components, such as to amplify wireless, Bluetooth, and any other peripheral requiring connectivity.

Having formed modular computer system 250 in FIGS. 16 and 17 by plugging host computer module 110 and power plug module 111 to either end of base module 50 according to the principle of the invention, modular computer system 250 is ready for use for computing purposes. To power modular computer system, a power cord is simply plugged into a power outlet and into power plug 170 (FIG. 13) of power plug module 111, ON/OFF switch 175 of power plug module 111 is turned ON to power base module 50 and host computer module 110, and ON/OFF switch 131 of computer module 110 is turned ON activating computer module 110. Output and input devices, namely, a keyboard and a monitor, plugged into base module 50 at peripheral interface connectors 60 of base module 50 are powered from base module 50 and interface with host computer module 110 in a conventional manner for operating computer module 110 and for displaying computer functions, wherein staticspeakers 73 of base module 50 provide auditory feedback/output to the user from host computer module 110 and/or to any peripheral device plugged into base module 50 and microphone 74 may be used for talking into host computer module 110 through base module 50 for, as a matter of example, interacting with voice-activated software, or voice-over IP, etc.

In the computer connecting position of host computer module 110 relative to base module 50 and in the power connecting position of power plug module 111 relative to base module 50 forming modular computer system 250, the respective modules are plugged together and form a compact and block-shaped, whereby sides 54, 124, and 164 are coplanar and so cooperate to form the front face of system 250, sides 55, 125, and 165 are coplanar and so cooperate to form the opposing rear face of system 250, the tops or upper ends 52, 122, and 162 are coplanar and so cooperate to form the top of system 250, and the bottoms or lower ends 53, 123, and 163 are coplanar and so cooperate to form a supporting bottom of system 250 positionable against a support surface, such as the surface of a desk or table.

In the computer connecting position of host computer module 110 relative to base module 50, free end 141 of rail segment 140 positioned near the top and side 124 of host computer module 110 diametrically opposes and is juxtaposed with free end 92 of rail segment 90 positioned near the top and side 54 of base module 50, and rail segment 90 of base module 50 is coaxial with respect to rail segment 140 of host computer module 110 such that rail segment 90 of base module 50 cooperates with rail segment 140 of host computer module 110 to form a peripherals-supporting rail that extends horizontally along the tops of base and host computer modules 50 and 110 along the front face of system 250. Furthermore, in the computer connecting position of host computer module 110 and the power connecting position of power plug module 111, free end 181 of rail segment 180 positioned near the top and side 164 of power plug module 111 diametrically opposes and is juxtaposed with free end 91 of rail segment 90 positioned near the top and side 54 of base module 50, and rail segment 180 of power plug module 111 is coaxial with respect to rail segment 90 of base module 50 and rail segment 140 of host computer module 110 such that rail segment 180 of power plug module 111 forms an extension of the peripherals-supporting rail formed by rail segments 90 and 140 of the base and host computer modules 50 and 110, in which all of these rail segments together cooperate to form a peripherals-supporting rail that extends horizontally along the tops of base, host computer, and power plug modules 50, 110, and 111 along the front face of system 250 and along the entire length of system 250 from free end 142 of rail segment 140 of host computer module 110 near end 127 of host computer module 110 to free end 182 of rail segment 180 of power plug module 111 near end 167 of power plug module 111.

Further in the computer connecting position of host computer module 110 relative to base module 50, free end 151 of rail segment 150 positioned near the top and side 125 of host computer module 110 diametrically opposes and is juxtaposed with free end 102 of rail segment 100 positioned near the top and side 55 of base module 50, and rail segment 100 of base module 50 is coaxial with respect to rail segment 150 of host computer module 110 such that rail segment 100 of base module 50 cooperates with rail segment 150 of host computer module 110 to form a peripherals-supporting rail that extends horizontally along the tops of base and host computer modules 50 and 110 along the rear face of system 250. Furthermore, in the computer connecting position of host computer module 110 and the power connecting position of power plug module 111, free end 191 of rail segment 190 positioned near the top and side 165 of power plug module 111 diametrically opposes and is juxtaposed with free end 101 of rail segment 100 positioned near the top and side 55 of base module 50, and rail segment 190 of power plug module 111 is coaxial with respect to rail segment 100 of base module 50 and rail segment 150 of host computer module 110 such that rail segment 190 of power plug module 111 forms an extension of the peripherals-supporting rail formed by rail segments 100 and 150 of the base and host computer modules 50 and 110, in which all of these rail segments together cooperate to form a peripherals-supporting rail that extends horizontally along the tops of base, host computer, and power plug modules 50, 110, and 111 along the rear face of system 250 and along the entire length of system 250 from free end 152 of rail segment 150 of host computer module 110 near end 127 of host computer module 110 to free end 192 of rail segment 190 of power plug module 111 near end 167 of power plug module 111. The peripherals-supporting rails of system 250 formed at the top of system 250 along front and rear faces of system 250 are parallel and oppose one another and are available to be used for securing and supporting computer peripherals for operating system 250, such as a keyboard and a monitor, and peripheral interface connectors 60 of base module 50 are formed along, and accessible at, the formed front and rear faces.

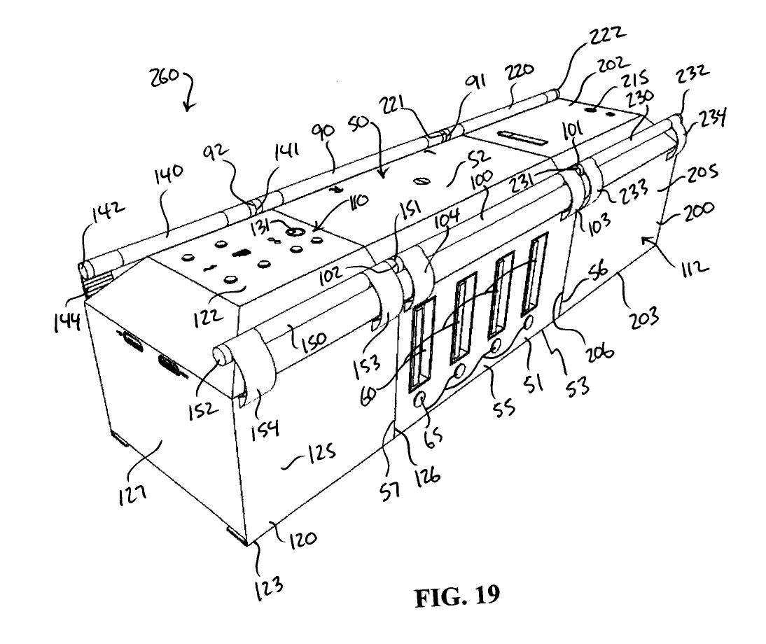

FIGS. 18 and 19 are perspective views of a module computer system 260 formed with host computer module 110 and battery module 112 plugged into base module 50. To form module computer system 260, which is powered by battery power from battery module 112, host computer module 110 and battery module 111 are plugged into base module 50 so as to operatively connect host computer module 110 and battery module 112 to base module 50. Host computer module 110 is plugged into base module 50 in its computer connecting position as described above.

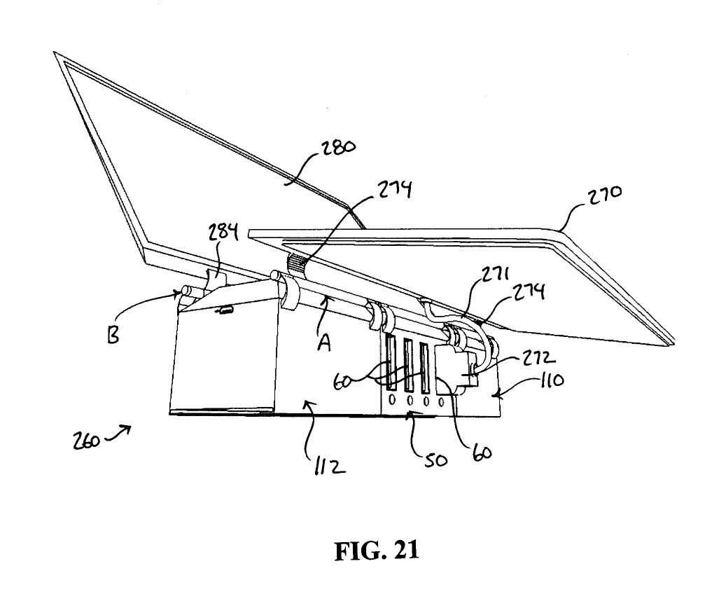

To plug battery module 112 into base module 50 in a battery connecting position of battery module 112 relative to base module 50 to power base module 50 and also host computer module 110 in the computer connecting position of host computer module 110, both are positioned upright next to each other from bottom to top and end 206 of battery module 112 formed with battery interface connector 211 and male contacts 81 is directed toward end 56 of base module 50 formed with module interface connector 61 and female contacts 80 so as to register battery interface connector 211 and male contacts 81 formed in end 206 of battery module 112 with module interface connector 61 and female contacts 80, respectively, formed in end 56 of base module 50. At this point, base module 50 and battery module 112 are simply pushed together plugging battery interface connector 211 of battery module 112 into module interface connector 61 of base module 50 and plugging male contacts 81 of battery module 112 into female contacts 80 of base module 50. By so plugging battery module 112 to base module 50 in the battery connecting position of battery module 112 relative to base module 50 as shown in FIGS. 16 and 21, end 206 of battery module 112 directly contacts end 56 of base module 50, battery module 112 is operatively coupled or otherwise connected to base module 50 at module interface connector 61 thereby operatively coupling the network of operatively coupled interface connectors 60, 61, and 62 of base module 50 to receive battery power from battery module 112 for powering host computer module 110 in the computer connecting position of host computer module 110, and for powering computer peripherals coupled to base module 50 through peripheral interface connectors 60 of base module 50, and male contacts 81 formed in end 66 of battery module 112 contact corresponding female contacts 80 formed in end 56 of base module 50 operatively connecting antenna 72 of base module 50 to the corresponding antenna of battery module 112 for providing antenna amplification for amplified wireless connectivity to networked components, such as to amplify wireless, Bluetooth, and any other peripheral requiring connectivity.

Having formed modular computer system 260 in FIGS. 18 and 19 by plugging host computer module 110 and battery module 112 to either end of base module 50 according to the principle of the invention, modular computer system 260 is ready for use for computing purposes. To power modular computer system, ON/OFF switch 215 of battery module 112 is turned ON to power base module 50 and host computer module 110, and ON/OFF switch 131 of computer module 110 is turned ON activating computer module 110. Output and input devices, namely, a keyboard and a monitor, plugged into base module 50 at peripheral interface connectors 60 of base module 50 are powered from base module 50 and interface with host computer module 110 in a conventional manner for operating computer module 110 and for displaying computer functions, wherein staticspeakers 73 of base module 50 provide auditory feedback to the user from host computer module 110 and microphone 74 may be used for talking into host computer module 110 through base module 50 for, as a matter of example, interacting with voice-activated software, or voice-over IP, etc.

In the computer connecting position of host computer module 110 relative to base module 50 and in the battery connecting position of battery module 112 relative to base module 50 forming modular computer system 260, the respective modules are plugged together and form a compact block, whereby sides 54, 124, and 204 are coplanar and so cooperate to form the front face of system 260, sides 55, 125, and 205 are coplanar and so cooperate to form the opposing rear face of system 260, the tops or upper ends 52, 122, and 202 are coplanar and so cooperate to form the top of system 260, and the bottoms or lower ends 53, 123, and 203 are coplanar and so cooperate to form a supporting bottom of system 260 positionable against a support surface, such as the surface of a desk or table.

In the computer connecting position of host computer module 110 and the battery connecting position of battery module 112, free end 221 of rail segment 220 positioned near the top and side 204 of battery module 112 diametrically opposes and is juxtaposed with free end 91 of rail segment 90 positioned near the top and side 54 of base module 50, and rail segment 220 of battery module 112 is coaxial with respect to rail segment 90 of base module 50 and rail segment 140 of host computer module 110 such that rail segment 220 of battery module 112 forms an extension of the peripherals-supporting rail formed by rail segments 90 and 140 of the base and host computer modules 50 and 110, in which all of these rail segments together cooperate to form a peripherals-supporting rail that extends horizontally along the tops of base, host computer, and battery modules 50, 110, and 112 along the front face of system 260 and along the entire length of system 260 from free end 142 of rail segment 140 of host computer module 110 near end 127 of host computer module 110 to free end 222 of rail segment 220 of battery module 112 near end 207 of battery module 112.

In the computer connecting position of host computer module 110 and the battery connecting position of battery module 112, free end 231 of rail segment 230 positioned near the top and side 205 of battery module 112 diametrically opposes and is juxtaposed with free end 101 of rail segment 100 positioned near the top and side 55 of base module 50, and rail segment 230 of battery module 112 is coaxial with respect to rail segment 100 of base module 50 and rail segment 150 of host computer module 110 such that rail segment 230 of battery module 112 forms an extension of the peripherals-supporting rail formed by rail segments 100 and 150 of the base and host computer modules 50 and 110, in which all of these rail segments together cooperate to form a peripherals-supporting rail that extends horizontally along the tops of base, host computer, and power plug modules 50, 110, and 111 along the rear face of system 260 and along the entire length of system 260 from free end 152 of rail segment 150 of host computer module 110 near end 127 of host computer module 110 to free end 232 of rail segment 230 of battery module 112 near end 207 of battery module 112. The peripherals-supporting rails of system 260 formed at the top of system 260 along front and rear faces of system 260 are parallel and oppose one another and are available to be used for securing and supporting computer peripherals for operating system 260, such as a keyboard and a monitor, and peripheral interface connectors 60 of base module 50 are formed along, and accessible at, the formed front and rear faces.

The usefulness of power plug module 111 in system 250 is to operate system 250 from a direct source of power by plugging power plug module 111 into a power outlet. Battery module 112 may be used instead of power plug module 111, and the usefulness of battery module 112 is to operate system 260 with battery power provided by battery module 112.

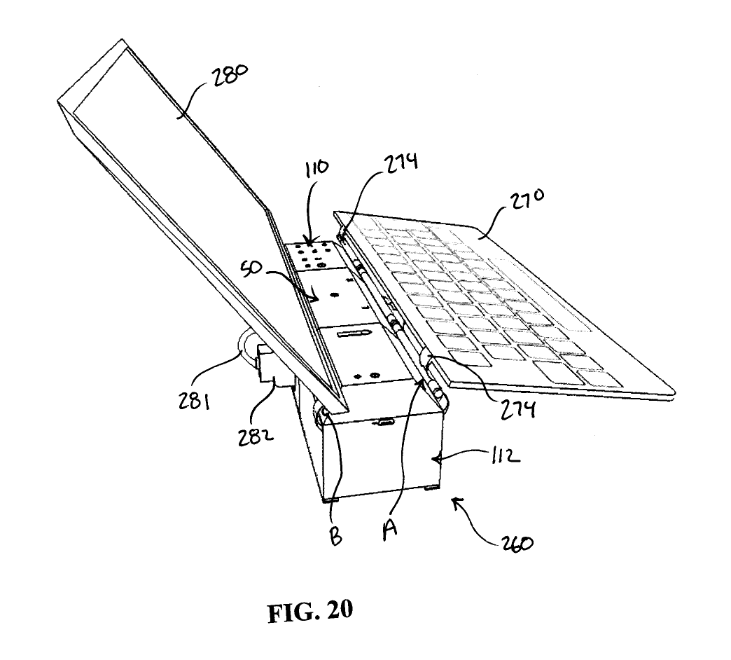

In modular computer systems constructed and arranged in accordance with the principle of the invention, input and output devices, such as a monitor and a keyboard, are operatively coupled at base module 50 by plugging these components into selected ones of peripheral interface connectors 60 formed in base module 50. As a matter of example, FIGS. 20-22 illustrate module computer system 260, which is formed by host computer module 110 and battery module 112 plugged into either side of base module 50, shown as it would appear with a keyboard 270 and a monitor 280.

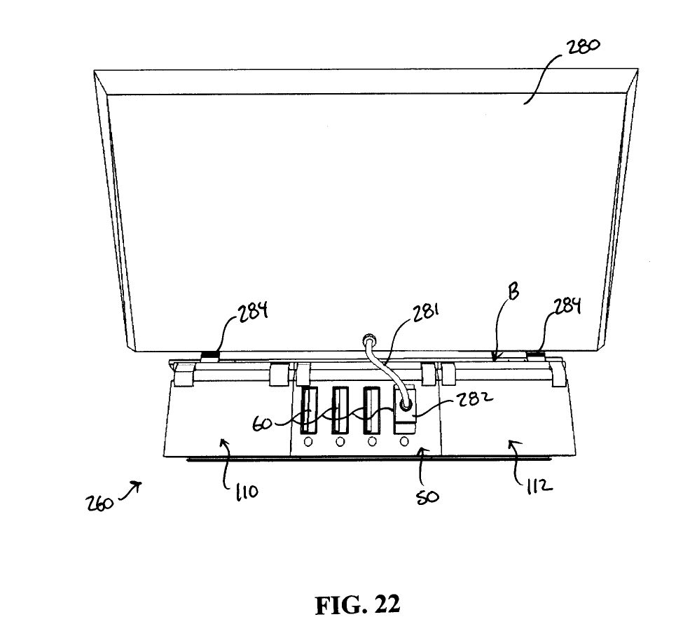

FIGS. 20-22 are perspective views of the module computer system of FIGS. 18 and 19 shown as it would appear formed with input and output devices, namely, a keyboard 270 and a separate monitor 280, both of which are conventional and well-known computer peripherals. As seen in FIG. 21, keyboard 270 is positioned along the front face of system 260 and is formed with an attached power cord 271 having a plug 272 plugged into one of peripheral interface connectors 60 formed in side 54 of base module 50 thereby operatively coupling keyboard 270 to host computer module 110 through the operative connection between host computer module 110 and base module 50 in the computer connecting position of host computer module 110. Because peripheral interface connectors 60 formed in side 54 of base module are female USB connectors, plug 272 is a conventional male USB plug that is conventionally plugged into one of peripheral interface connectors 60 formed in side 54 of base module 50. As seen in FIG. 22, monitor 280 is positioned along the rear face of system 260 and is formed with an attached power cord 281 having a plug 282 plugged into one of peripheral interface connectors 60 formed in side 55 of base module 50 thereby operatively coupling monitor 280 to host computer module 110 through the operative connection between host computer module 110 and base module 50 in the computer connecting position of host computer module 110. Because peripheral interface connectors 60 formed in side 55 of base module are female USB connectors, plug 282 is a conventional male USB plug that is conventionally plugged into one of peripheral interface connectors 60 formed in side 55 of base module 50. Having plugged keyboard 270 and monitor 280 into system 260 at base module 50, keyboard 270 and monitor 280 are free to be used for operating host computer module 110 in a normal manner, whereby keyboard is used to enter inputs into host computer module 110 and monitor 280 provides the corresponding display outputs.

As previously mentioned, the peripherals-supporting rails of system 260 formed at the top of system 260 along front and rear faces of system 260 are useful for securing and supporting computer peripherals for operating system 260, such as keyboard 270 and monitor 280. In FIGS. 20-22, the peripherals-supporting rail along front face of system 260 is denoted generally at A and the peripheral supporting rail along rear face of system 260 is denoted generally at B. As shown in FIGS. 20 and 21, Keyboard 270 is formed with conventional clips 274 that are clipped to rail A securing keyboard 270 to system 260 along the front face of system 260 as illustrated in FIGS. 20-22, and as shown in FIG. 22 monitor 280 is formed with conventional clips 284 that are clipped to rail B securing monitor 280 to system 260 along the rear face of system 260, and which is supported upright for easy viewing by a user in front of keyboard 270. Rails A and B provide a convenient way to secure and support a keyboard and a monitor. However, a monitor and a keyboard used with system 260 need not be secured to rails A and B and may simply be set alongside system 260. Incorporating keyboard 270 and monitor 280 with system 260 occupies two of the eight peripherals interface connectors 60 formed in base module 50, and the remaining six peripherals interface connectors 60 may be used with other computer peripherals, such as a printer, a scanner, a camera, etc. FIGS. 20-22 shown an exemplary configuration of system 260 with keyboard 270 and monitor 280 applied to the peripherals-supporting rails, and system 250 discussed above may also be identically configured with keyboard 270 and monitor 280 applied to the peripherals-supporting rails of system 250.

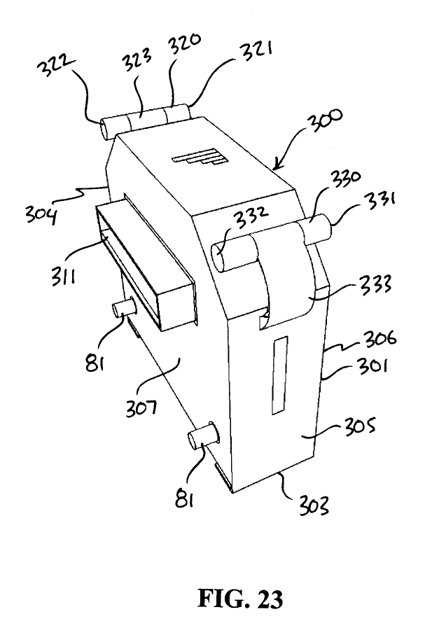

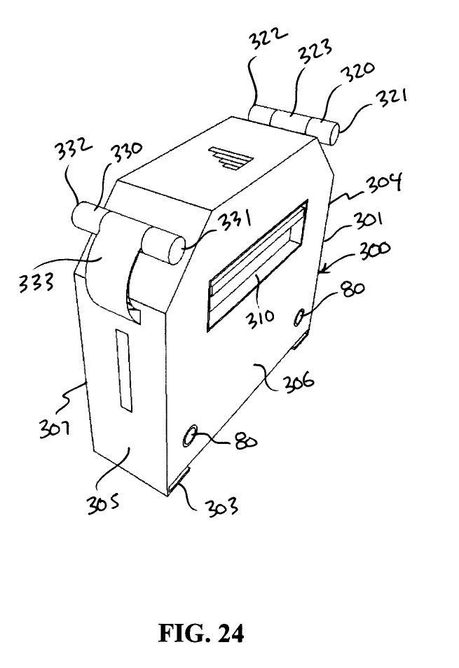

The combination of base module 50 and computer module 110 forms the basic computer system of modular computer systems 250 and 260, which is powered by power plug module 111 in system 250 and which is powered by battery module 112 in system 260. In both systems 250 and 260, additional peripheral modules for performing peripheral functions for expanding the computer functions of host computer module 110 may be incorporated into systems 250 and 260. An example of a peripheral module is illustrated in FIGS. 23 and 24, and is denoted generally at 300.

Looking to FIGS. 23 and 24 in relevant part, peripheral module 300 is used for performing a peripheral function for expanding the computer functions of host computer module 110 in the computer connecting position of host computer module 110. Peripheral module 300 is fully self-contained, and includes a housing 301 having opposed horizontal upper and lower ends 302 and 303 and opposed vertical sides 304 and 305 that extend between opposed vertical ends 306 and 307. Upper and lower ends 302 and 303, and sides 304 and 305 cooperate to form the middle of housing 301 of peripheral module 300, and this defined middle extends between opposed ends 306 and 307 of housing 301 of peripheral module 300. Housing 301, and thus peripheral module 300, is compact, in which upper end 302 is parallel with respect to lower end 303, side 304 is parallel with respect to side 305, and end 306 is parallel with respect to end 307. Housing 301 is formed of plastic or metal, and upper end 302 forms the top of peripheral computer module 300, and lower end 303 forms the bottom of peripheral computer module 300.

Peripheral module 300 is formed with computer peripheral interface connectors 310 and 311, which are operatively coupled to a computer peripheral system formed in housing 301. Computer peripheral interface connectors 310 and 311 are used to operatively couple peripheral module 300 to module components of a module computer system according to the invention. In the present embodiment, the computer peripheral system formed in housing 301 is a cellular component used to provide telephonic access to a cellular telephonic network. The cellular component of peripheral module 300 is entirely conventional, and may be configured to comply with a selected cellular telephonic standard, such as the code division multiple access (CDMA) standard, the global system for mobile (GSM) communications standard, or other standard.

Computer peripheral interface connector 310 is formed in end 306 of housing 301 and is exposed at end 306 so as to be available for use, and computer peripheral interface connector 311 is formed in end 307 of housing 301 and is exposed at end 307 so as to be available for use. Computer peripheral interface connectors 310 and 311 each comply with a USB standard and, as such, are each standard USB interface connectors well known in the art. Computer peripheral interface connectors 310 and 311 are preferably conventional USB 3.0 interface connectors for providing high transfer rates, and in an alternate embodiment are USB 2.0 interface connectors. Computer peripheral interface connector 310 is a conventional female USB interface connectors that conventionally accept corresponding male USB interface connectors/plugs, and computer peripheral interface connector 311 is a conventional male USB interface connector that is conventionally received by a corresponding female USB interface connector.

Like base module 50, host computer module 110, power plug module 111, and battery module 112, peripheral module 300 incorporates a conventional or standard wireless network antenna inside housing 301 just like that of the antennas of the other modules, and which, as in base module 50, is electrically and operatively connected to contact structures formed in peripheral module 300 with conventional electrical circuitry, including one contact structure formed in end 306 of housing 301, and another contract structure formed in end 307 of housing 51. The contact structure formed in end 306 consists of opposed female contacts 80, and the contract structure formed in end 307 consists of opposed male contacts 81.

Peripheral module 300 is useful in system 250 and also in system 260. When applied to systems 250 and 260, peripheral module 300 functions to perform a peripheral function for expanding the computer functions of host computer module 110. In the present embodiment, peripheral module 300 incorporates a cellular component used to provide telephonic access to a cellular telephonic network for making cellular calls over a cellular network, which thus expands the computer functions of host computer module 110. In system 250, peripheral module 300 is applied between host computer module 110 and base module 50, and in system 260 peripheral module 300 is applied between battery module 112 and base module 50. The application and interface of peripheral module in system 250 is identical to that for system 260. As such, the details of the application of peripheral module 300 in system 260 will be discussed, with the understanding the ensuing description of the application of peripheral module 300 in system 260 applies equally to the application of peripheral module 300 to system 250.

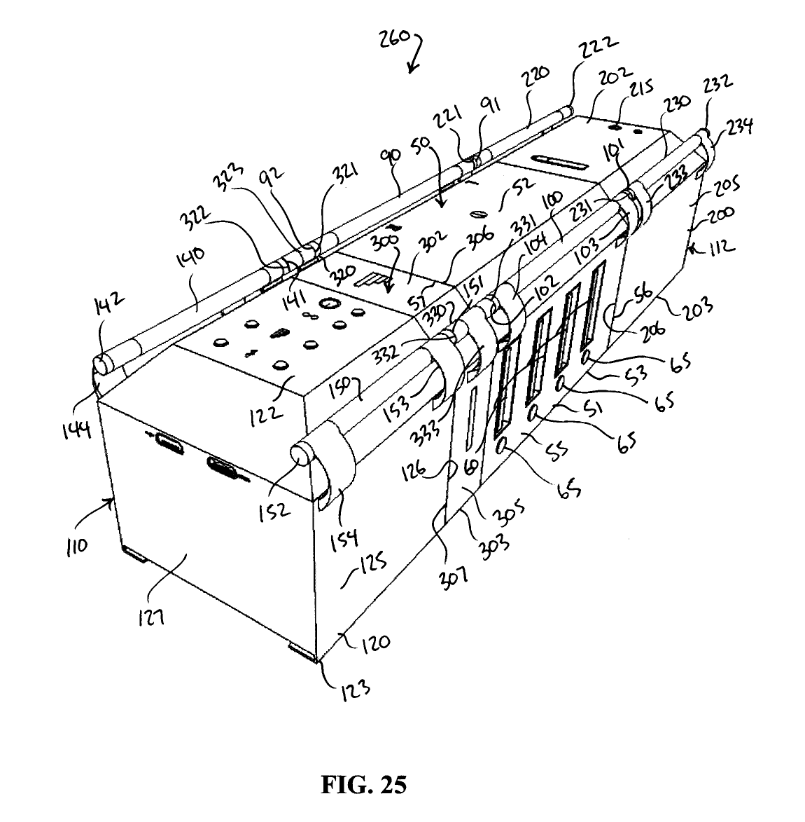

Computer peripheral interface connector 310 is operatively connectable directly to module interface connector 62 of base module 50 in a peripheral connecting position of peripheral module 300 relative to base module 50, shown for example in FIG. 25, for operatively coupling the network of interface connectors 60, 61, and 62 of base module 50 to peripheral module 300 for, in turn, operatively coupling peripheral interface connectors 60 of base module 50 to peripheral module 300 for operatively coupling peripheral module 300 to computer peripherals coupled to base module 50 through peripheral interface connectors 60 of base module 50, and for operatively coupling peripheral module 300 to receive power from base module 50 supplied to base module 50 from battery module 112 in the battery connecting position of battery module 112, and which would be from power plug module 111 in system 250.

Computer interface connector 130 is operatively connectable directly to computer peripheral interface connector 311 in a computer connecting position of host computer module 110 relative to peripheral module 300 for operatively coupling host computer module 110 to peripheral module 300, and in the peripheral connecting position of peripheral module 300 for operatively coupling host computer module 110 to the network of interface connectors 60, 61, and 62 of base module 50 for, in turn, operatively coupling host computer module 110 to computer peripherals coupled to base module 50 through peripheral interface connectors 60 of base module 50, and for operatively coupling host computer module 110 to receive power from peripheral module 300 supplied to peripheral module 300 from battery module 112 operatively coupled to base module 50 in the battery connecting position of battery module 112, and which would be from power plug module 111 in system 250.

With continuing reference to FIGS. 23 and 24 in relevant part, peripheral module 300 is formed with opposed rail segments 320 and 330, which are used to receive and support computer peripherals, such as input and output devices. Rail segment 320 is formed exteriorly of housing 310 alongside of side 314 of housing 310, and rail segment 330 is formed exteriorly of housing 310 alongside of side 315 of housing 310. Rail segment 320 and 330 are elongate and are equal in size and shape. Rail segment 320 has opposed free ends 321 and 322, and is spaced-apart from, and is fixed horizontally to, side 314 of housing 310 of peripheral module 300 near upper end 312 of housing 310 with a strut 323 attached between side 314 of housing 310 and rail segment 320. Rail segment 320 extends horizontally alongside of side 314 of housing 310 of peripheral module 300 from free end 321 of rail segment 320 near end 316 of housing 310 to free end 322 of rail segment 320 near end 317 of housing 310. Rail segment 330 has opposed free ends 331 and 332, and is spaced-apart from, and is fixed horizontally to, side 315 of housing 310 of peripheral module 300 near upper end 312 of housing 310 with a strut 333 attached between side 315 of housing 310 and rail segment 330. Rail segment 330 extends horizontally alongside of side 315 of housing 310 of peripheral module 300 from free end 331 of rail segment 320 near end 316 of housing 310 to free end 332 of rail segment 330 near end 177 of housing 310. Rail segments 320 and 330 oppose one another on either side of housing 310 of peripheral module 300, and are parallel with respect to each other.

To incorporate peripheral module 300 into modular computer system 260 as shown in FIG. 25, peripheral computer module 300 is plugged into base module 50 in a peripheral connecting position of peripheral module 300, and host computer module 110 is, in turn, plugged into peripheral module 300 in a computer connecting position of host computer module 110. To plug peripheral module 300 into base module 50 in a peripheral connecting position of peripheral module 300, both are positioned upright next to each other from bottom to top and end 306 of peripheral module 300 formed with computer peripheral interface connector 310 and female contacts 80 is directed toward end 57 of base module 50 formed with module interface connector 62 and male contacts 81 so as to register computer peripheral interface connector 310 and female contacts 80 formed in end 306 of peripheral module 300 with module interface connector 62 and male contacts 81, respectively, formed in end 57 of base module 50. At this point, base module 50 and peripheral module 300 are simply pushed together plugging module interface connector 62 of base module 50 into computer peripheral interface connector 310 of peripheral module 300 and plugging male contacts 81 of base module 50 into female contacts 80 of peripheral module 300. By so plugging peripheral module 300 to base module 50 in the peripheral connecting position of peripheral module 300 relative to base module 50 as shown in FIG. 25, end 306 of peripheral module 300 directly contacts end 57 of base module 50, peripheral module 300 is operatively coupled or otherwise connected to base module 50 at module interface connector 62 thereby operatively coupling peripheral module 300 to peripheral interface connectors 60 of base module 50 for, in turn, operatively coupling peripheral module 300 to computer peripherals coupled to base module 50 through peripheral interface connectors 60 of base module 50, and male contacts 81 formed in end 57 of base module 50 contact corresponding female contacts 80 formed in end 126 of peripheral module 300 operatively connecting antenna 72 of base module 50 to the corresponding antenna of peripheral module 300 for providing antenna amplification for amplified wireless connectivity to networked components, such as to amplify wireless and Bluetooth connectivity to networked components.

To plug host computer module 110 into peripheral module 300 in a computer connecting position of host computer module 110 relative to peripheral module 300 and relative to base module in the peripheral connecting position of peripheral module 300, both are positioned upright next to each other from bottom to top and end 126 of host computer module 110 formed with computer interface connector 130 and female contacts 80 is directed toward end 307 of peripheral module 300 formed with computer peripheral interface connector 311 and male contacts 81 so as to register computer interface connector 130 and female contacts 80 formed in end 126 of host computer module 110 with computer peripheral interface connector 311 and male contacts 81, respectively, formed in end 307 of peripheral module 300. At this point, peripheral module 300 and host computer module 110 are simply pushed together plugging computer peripheral interface connector 311 of peripheral module 300 into computer interface connector 130 of host computer module 110 and plugging male contacts 81 of peripheral module 300 into female contacts 80 of host computer module 110. By so plugging host computer module 110 to peripheral module 300 in the computer connecting position of host computer module 110 relative to peripheral module 300 and relative to base module 50 in the peripheral connecting position of peripheral module 300 relative to base module 50 as shown in FIG. 25, end 126 of host computer module 110 directly contacts end 307 of peripheral module 300, host computer module 110 is operatively coupled or otherwise connected to peripheral module 300 at computer peripheral interface connector 311 thereby operatively coupling host computer module 110 to peripheral interface connectors 60 of peripheral module 300 for, in turn, operatively coupling host computer module 110 to computer peripherals coupled to peripheral module 300 through peripheral interface connectors 60 of peripheral module 300, and male contacts 81 formed in end 307 of peripheral module 300 contact corresponding female contacts 80 formed in end 126 of host computer module 110 operatively connecting antenna 72 of peripheral module 300 to the corresponding antenna of host computer module 110 for providing antenna amplification for amplified wireless connectivity to networked components, such as to amplify wireless and Bluetooth connectivity to networked components. With battery 112 in its battery connecting position relative base module 50, in the peripheral connecting position of peripheral module 300 and in the computer connecting position of host computer module 110, base module 50, peripheral module 300, and host computer module 110 are operatively coupled to receive battery power from battery module 112, and they would otherwise be operatively coupled to receive power from power plug module 111 in system 250.

Having formed modular computer system 260 in FIG. 25 incorporating peripheral module 300 by plugging peripheral module 300 and battery module 112 to either end of base module 50 according to the principle of the invention and by plugging host computer module 110 into peripheral module 300, modular computer system 260 is ready for use for computing purposes. To power modular computer system, ON/OFF switch 215 of battery module 112 is turned ON to power base module 50 and peripheral module 300 and host computer module 110, and ON/OFF switch 131 of computer module 110 is turned ON activating computer module 110. Output and input devices, namely, a keyboard and a monitor, plugged into base module 50 at peripheral interface connectors 60 of base module 50 are powered from base module 50 previously described and interface with host computer module 110 in a conventional manner for operating computer module 110 and for displaying computer functions and for accessing a cellular telephonic network with peripheral module 300, wherein staticspeakers 73 of base module 50 provide auditory feedback to the user from host computer module 110 and microphone 74 may be used for talking into host computer module 110 through base module 50 for, for instance, interacting with voice-activated software, or voice-over IP, etc.

In the computer connecting position of host computer module 110, in the peripheral connecting position of peripheral module 300, and in the battery connecting position of battery module 112 forming modular computer system 260 in FIG. 25, the respective modules are plugged together and form a compact block, whereby sides 54, 124, 204, and 304 are coplanar and so cooperate to form the front face of system 260, sides 55, 125, 205, and 305 are coplanar and so cooperate to form the opposing rear face of system 260, the tops or upper ends 52, 122, 202, and 302 are coplanar and so cooperate to form the top of system 260, and the bottoms or lower ends 53, 123, 203, and 303 are coplanar and so cooperate to form a supporting bottom of system 260 positionable against a support surface, such as the surface of a desk or table.

In the peripheral connecting position of peripheral module and the computer connecting position of host computer module 110 in system 260 depicted in FIG. 25, free end 141 of rail segment 140 positioned near the top and side 124 of host computer module 110 diametrically opposes and is juxtaposed with free end 322 of rail segment 320 positioned near the top and side 304 of peripheral module 300 and rail segment 320 is coaxial with respect to rail segment 140 of host computer module 110, and free end 321 of rail segment 320 positioned near the top and side 304 of peripheral module 300 diametrically opposes and is juxtaposed with free end 92 of rail segment 90 of base module 50 positioned near the top and side of base module 50, and rail segment 90 is coaxial with respect to rail segment 320 of peripheral module 300 and rail segment 140 of host computer module 110 such that rail segment 90 of base module 50 cooperates with rail segment 320 of peripheral module 300 and rail segment 140 of host computer module 110 to form a peripherals-supporting rail that extends horizontally along the tops of base, computer peripheral, and host computer modules 50, 300, and 110 along the front face of system 260.

In the peripheral connecting position of peripheral module 300 and the computer connecting position of host computer module 110 and in the battery connecting position of battery module 112, free end 221 of rail segment 220 of battery module 112 positioned near the top and side 204 of battery module 112 diametrically opposes and is juxtaposed with free end 91 of rail segment 90 positioned near the top and side 54 of base module 50, and rail segment 220 of battery module 112 is coaxial with respect to rail segment 90 of base module 50, rail segment 320 of peripheral module 300, and rail segment 140 of host computer module 110 such that rail segment 220 of battery module 112 forms an extension of the peripherals-supporting rail formed by rail segments 90, 320, and 140, in which all of these rail segments together cooperate to form a peripherals-supporting rail that extends horizontally along the tops of base, computer peripheral, host computer, and battery modules 50, 300, 110, and 112 along the front face of system 260 and along the entire length of system 260 from free end 142 of rail segment 140 of host computer module 110 near end 127 of host computer module 110 to free end 222 of rail segment 220 of battery module 112 near end 207 of battery module 112.

It is to be understood that in the peripheral connecting position of peripheral module 300 and the computer connecting position of host computer module 110 and in the power connecting position of battery module 111 of system 250, free end 181 of rail segment 180 positioned near the top and side 164 of power plug module 111 diametrically opposes and is juxtaposed with free end 91 of rail segment 90 positioned near the top and side 54 of base module 50, and rail segment 180 of power plug module 111 is coaxial with respect to rail segment 90 of base module 50, rail segment 320 of peripheral module 300, and rail segment 140 of host computer module 110 such that rail segment 180 of power plug module 111 forms an extension of the peripherals-supporting rail formed by rail segments 90, 320, and 140, in which all of these rail segments together cooperate to form a peripherals-supporting rail that extends horizontally along the tops of base, host computer, and power plug modules 50, 110, and 111 along the front face of system 250 and along the entire length of system 250 from free end 142 of rail segment 140 of host computer module 110 near end 127 of host computer module 110 to free end 182 of rail segment 180 of power plug module 111 near end 167 of power plug module 111.

In the peripheral connecting position of peripheral module and the computer connecting position of host computer module 110 in system 260 depicted in FIG. 25, free end 151 of rail segment 150 positioned near the top and side 125 of host computer module 110 diametrically opposes and is juxtaposed with free end 332 of rail segment 330 positioned near the top and side 305 of peripheral module 300 and rail segment 330 is coaxial with respect to rail segment 150 of host computer module 110, and free end 331 of rail segment 330 positioned near the top and side 305 of peripheral module 300 diametrically opposes and is juxtaposed with free end 102 of rail segment 100 of base module 50 positioned near the top and side of base module 50, and rail segment 100 is coaxial with respect to rail segment 330 of peripheral module 300 and rail segment 150 of host computer module 110 such that rail segment 100 of base module 50 cooperates with rail segment 330 of peripheral module 300 and rail segment 150 of host computer module 110 to form a peripherals-supporting rail that extends horizontally along the tops of base, computer peripheral, and host computer modules 50, 300, and 110 along the rear face of system 260.

In the peripheral connecting position of peripheral module 300 and the computer connecting position of host computer module 110 and in the battery connecting position of battery module 112, free end 231 of rail segment 230 of battery module 112 positioned near the top and side 205 of battery module 112 diametrically opposes and is juxtaposed with free end 101 of rail segment 100 positioned near the top and side 55 of base module 50, and rail segment 230 of battery module 112 is coaxial with respect to rail segment 100 of base module 50, rail segment 330 of peripheral module 300, and rail segment 150 of host computer module 110 such that rail segment 230 of battery module 112 forms an extension of the peripherals-supporting rail formed by rail segments 100, 330, and 150, in which all of these rail segments together cooperate to form a peripherals-supporting rail that extends horizontally along the tops of base, computer peripheral, host computer, and battery modules 50, 300, 110, and 112 along the rear face of system 260 and along the entire length of system 260 from free end 142 of rail segment 140 of host computer module 110 near end 127 of host computer module 110 to free end 222 of rail segment 220 of battery module 112 near end 207 of battery module 112.

It is to be understood that in the peripheral connecting position of peripheral module 300 and the computer connecting position of host computer module 110 and in the power connecting position of battery module 111 of system 250, free end 191 of rail segment 190 positioned near the top and side 165 of power plug module 111 diametrically opposes and is juxtaposed with free end 101 of rail segment 100 positioned near the top and side 55 of base module 50, and rail segment 190 of power plug module 111 is coaxial with respect to rail segment 100 of base module 50, rail segment 330 of peripheral module 300, and rail segment 150 of host computer module 110 such that rail segment 190 of power plug module 111 forms an extension of the peripherals-supporting rail formed by rail segments 100, 330, and 150, in which all of these rail segments together cooperate to form a peripherals-supporting rail that extends horizontally along the tops of base, host computer, and power plug modules 50, 110, and 111 along the rear face of system 250 and along the entire length of system 250 from free end 142 of rail segment 140 of host computer module 110 near end 127 of host computer module 110 to free end 182 of rail segment 180 of power plug module 111 near end 167 of power plug module 111.

The peripherals-supporting rails of system 260 formed at the top of system 260 along front and rear faces of system 260 as shown in FIG. 25 are parallel and oppose one another and are available to be used for securing and supporting computer peripherals for operating system 260, such as a keyboard and a monitor, and this is also applies to system 250 incorporating computer peripherals module 300.

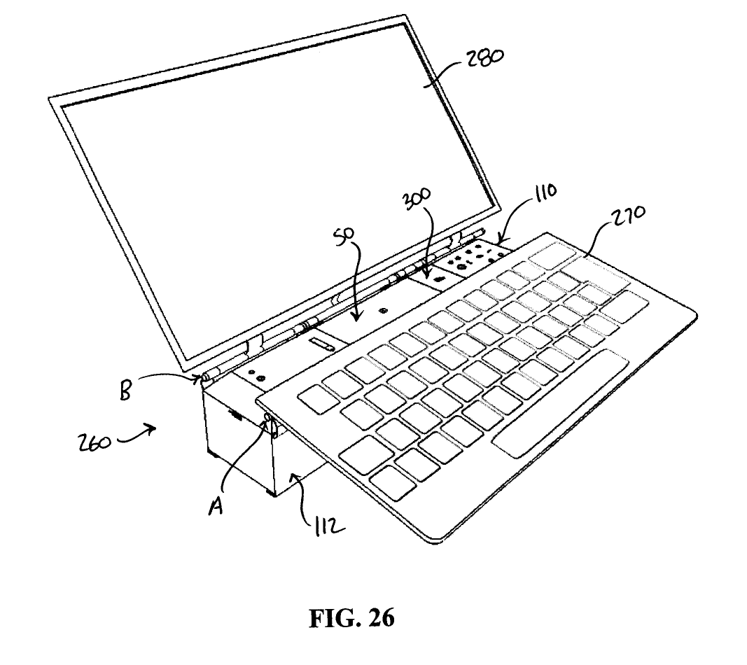

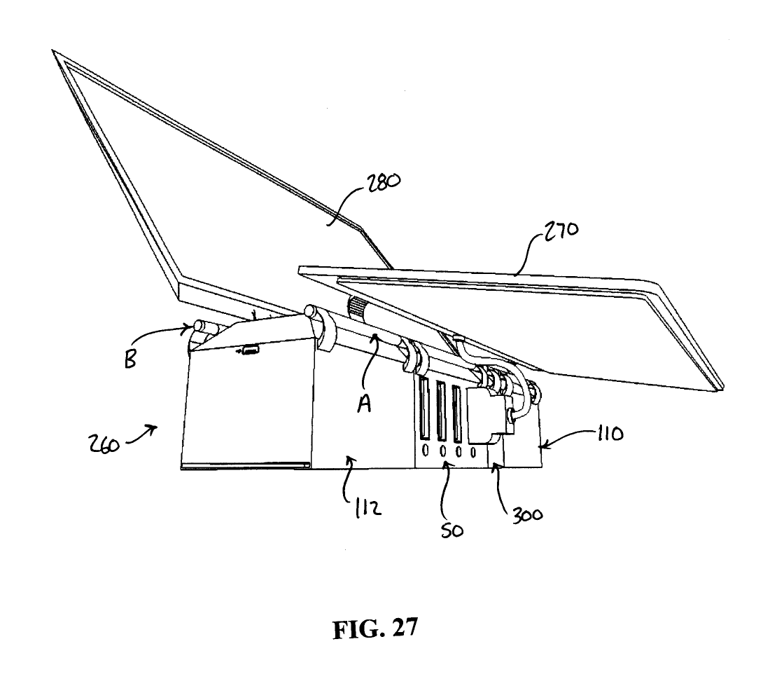

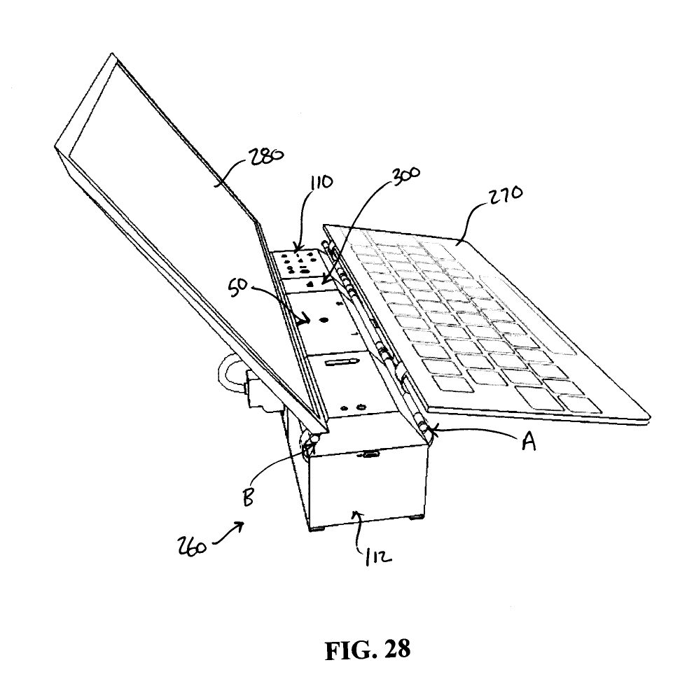

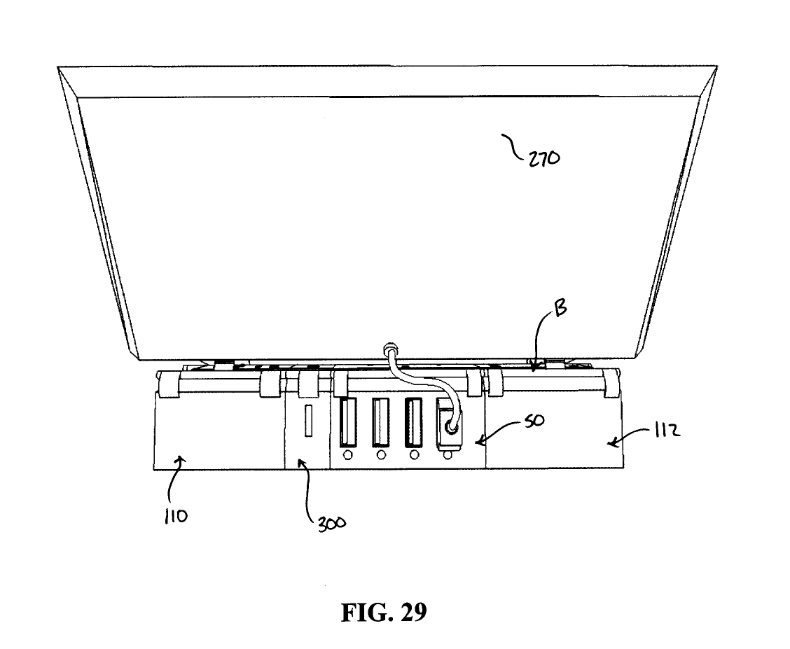

As a matter of example, FIGS. 26-29 illustrate module computer system 260 which is formed by computer peripherals module 300 and battery module 112 plugged into either side of base module 50 and host computer module 110 plugged into computer peripherals module 300 shown as it would appear with keyboard 270 and a monitor 280, which are plugged into base module 50 as previously explained. In FIGS. 26-29, the peripherals-supporting rail along front face of system 260 is denoted generally at A, the peripheral supporting rail along rear face of system 260 is denoted generally at B, and keyboard 270 and monitor 280 are applied to rails A and B, respectively, in the manner previously described.

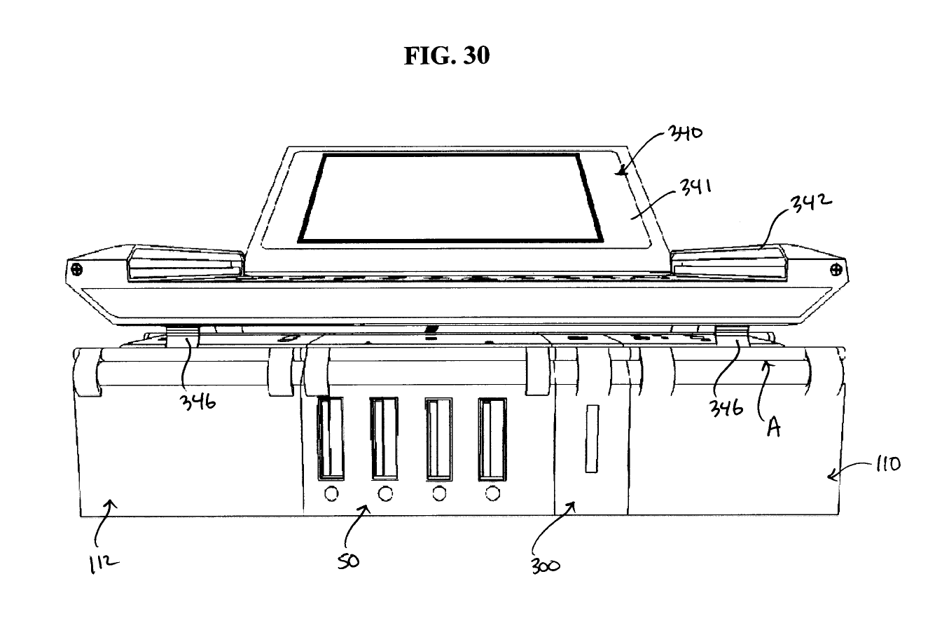

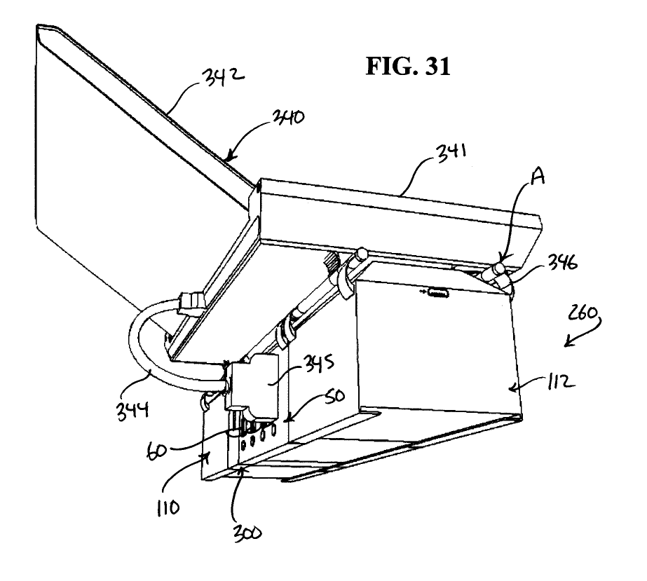

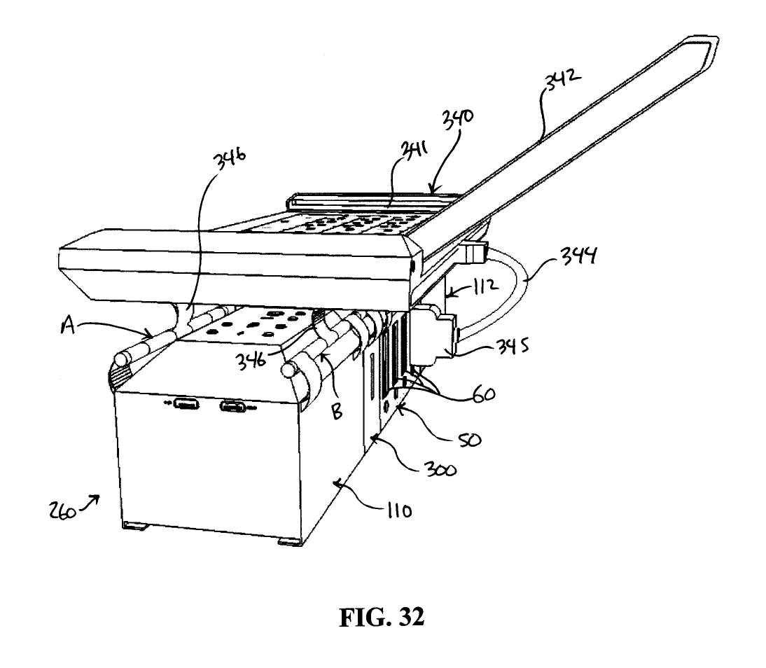

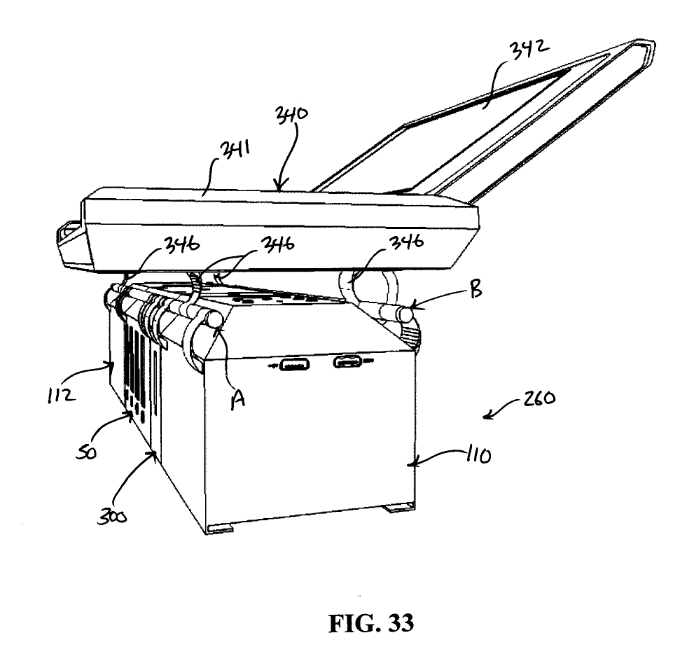

In FIGS. 20-22 and FIGS. 26-29, the two embodiments of module computer system 260 are shown configured with input and output devices consisting of a keyboard and a separate monitor separately plugged into base module 50. If desired, the input and output devices consisting of a keyboard and a monitor can be configured as an integrated device as shown in FIGS. 30-33, in which there is shown system 260 of FIG. 25 configured with an interface device 340 having an integrated keyboard 341 and monitor 342. Interface device 340 is exemplary of a cellular phone other device having an integrated keyboard and monitor, and which is shown as it would appear having a power cord 344 formed with a plug 345 plugged into one of the peripheral interface connector 60 formed in side 55 of base module 50, and which is further shown as it would appear support atop peripherals-supporting rails A and B with clips 346 applied between interface device 340 and peripherals-supporting rails A and B.

Peripheral module 300 set forth in this disclosure is a cellular appliance used to provide telephonic access to a cellular telephonic network and this characterizes the functionality of peripheral module 300. A peripheral module useful in the module computer systems set forth in this disclosure may be configured to carry out other functions, and other forms of peripheral modules for carrying out other functions may be provided and used to form module computer system embodiments. A peripheral module like that of peripheral module 300 may be configured to perform different functions. Examples of peripheral modules that may be used include, for example, a global-positioning system (GPS) module for performing GPS functions, a fingerprint reader module for providing finger-print log-in, an infra-red signal module for providing remote connections using infra-red signals, a Bluetooth module, a wireless internet access module for providing wireless internet access, a hard drive module for providing additional storage, a CD module, a DVD module, a stereo module, a card reader module for reading a memory card, a television module for providing television connectivity, etc.

Those having ordinary skill in the art will readily appreciate that exemplary module computer systems are disclosed, which include various modules including self-contained base module 50, self-contained host computer module 110, power modules including a power plug module 111 and battery module 112, and peripheral module 113, which may be plugged together as disclosed in various configurations as disclosed to form module computer systems. The combination of base module 50 and computer module 110 forms the basic computer system of modular computer systems 250 and 260, which may be powered by power plug module 111 as in system 250, and which may be powered by battery module 112 in system 260. Peripheral module 300 may be incorporated and plugged between base module 50 and host computer module 110 for providing additional functionality. The various modules are easy to construct, portable and easily carried about, and interchangeable, and when plugged together form peripherals-supporting rails useful for securing and holding computer peripherals, such as keyboard 270 and monitor 280 as herein specifically disclosed. The various modules may be replaced when broken, or independently fixed and serviced as may be required. The power plug module 111 and the battery module 113 are each exemplary of power modules used to power the module computer systems set forth herein, and each may be configured with conventional surge protectors for providing power surge protections. Furthermore, host computer module 110 may be configured with database options, such as an options database, for making the modular computers systems constructed and arranged in accordance with the principle of the invention easier to use with other computer peripherals and peripheral modules. The various interface connectors of the corresponding modules each comply with a USB standard, such as a 2.0 standard, or a 3.0 standard, and each of the various interface connectors may be configured to comply with other USB standards as they are developed without departing from the invention. Also, although various ones of the interface connectors of the various modules are female connectors and others are male connectors, this is set forth as a matter of example and each may be either a male connector or a female connectors as may be desired consistent with the teachings of the various embodiments of the invention. Furthermore, the various computer system embodiments of the invention may be configured to interface wireless with input and output devices, such as monitors and keyboards, as may be desired with conventional wireless interface systems. Furthermore, keyboard and monitor input and output devices useful with the various computer system embodiments of the invention can be provided in any form and size.

The invention has been described above with reference to preferred embodiments. However, those skilled in the art will recognize that changes and modifications may be made to the embodiments without departing from the nature and scope of the invention. Various changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A module computer system, comprising:
a self-contained base module includes a network of operatively coupled interface connectors including peripheral interface connectors and a first module interface connector; and
a self-contained host computer module for performing computer functions, and which includes a computer interface connector operatively connectable directly to the first module interface connector of the base module in a computer connecting position of the host computer module for operatively coupling the peripheral interface connectors of the base module to the host computer module for, in turn, operatively coupling the host computer module to computer peripherals, such as a keyboard and a monitor, coupled to the base module through the peripheral interface connectors of the base module.

2. The module computer system according to claim 1, the interface connectors of the base module further includes a second module interface connector.

3. The module computer system according to claim 2, further comprising a self-contained power module that includes a power interface connector operatively connectable directly to the second module interface connector of the base module in a power connecting position of the power module for operatively coupling the network of operatively coupled interface connectors of the base module to receive power from the power module for powering the host computer module in the computer connecting position of the host computer module, and for powering computer peripherals coupled to the base module through the peripheral interface connectors of the base module.

4. The module computer system according to claim 3, wherein the power module further comprises a power plug module.

5. The module computer system according to claim 3, wherein the power module further comprises a battery power module.

6. The module computer system according to claim 3, wherein the interface connectors of the base module, the computer interface connector of the host computer module, and the power interface connector of the power module each comply with a USB standard.

7. The module computer system according to claim 6, further comprising:
a base module rail segment spaced-apart from, and fixed horizontally to, the base module;
a host computer module rail segment spaced-apart from, and fixed horizontally to, the host computer module; and
in the computer connecting position of the host computer module, the base module rail segment cooperates with the host computer module rail segment to form a peripherals-supporting rail that extends horizontally along the base and host computer modules.

8. The module computer system according to claim 7, further comprising:
a power module rail segment spaced-apart from, and fixed horizontally to, the power module; and
in the computer connecting position of the host computer module and the power connecting position of the power module, the power module rail segment relates to the base module rail segment so as to form an extension of the peripherals-supporting rail thereby forming a part of the peripherals-supporting rail.

9. The module computer system according to claim 8, wherein in the computer connecting position of the host computer module and the power connecting position of the power module, the base module, the host computer module, and the power module cooperate to form a supporting bottom positionable against a support surface.

10. The module computer system according to claim 9, wherein in the computer connecting position of the host computer module and the power connecting position of the power module, the base module, the host computer module, and the power module cooperate to form opposed, parallel front and rear faces, wherein the peripheral interface connectors of the base module are formed along, and accessible at, the front and rear faces.

11. A module computer system, comprising:
a self-contained base module includes a network of operatively coupled interface connectors including peripheral interface connectors, and a first module interface connector;
a self-contained host computer module for performing computer functions;
a self-contained peripheral module for performing a peripheral function for expanding the computer functions of the host computer module, the peripheral module includes a first computer peripheral interface connector operatively connectable directly to the first module interface connector of the base module in a peripheral connecting position of the peripheral module for operatively coupling the peripheral interface connectors of the base module to the peripheral module for operatively coupling the peripheral module to computer peripherals coupled to the base module through the peripheral interface connectors of the base module, and a second computer peripheral interface connector; and
the host computer module includes a computer interface connector operatively connectable directly to the second computer peripheral interface connector in a computer connecting position of the host computer module for operatively coupling the host computer module to the peripheral module, and in the peripheral connecting position of the peripheral module for operatively coupling the host computer module to the peripheral interface connectors of the base module for, in turn, operatively coupling the host computer module to computer peripherals coupled to the base module through the peripheral interface connectors of the base module.

12. The module computer system according to claim 11, the interface connectors of the base module further includes a second module interface connector.

13. The module computer system according to claim 12, further comprising a self-contained power module that includes a power interface connector operatively connectable directly to the second module interface connector of the base module in a power connecting position of the power module for operatively coupling the network of operatively coupled interface connectors of the base module to receive power from the power module for powering the peripheral module in the peripheral connecting position of the peripheral module, for powering the host computer module in the peripheral connecting position of the peripheral module and the computer connecting position of the host computer module, and for powering computer peripherals coupled to the base module through the peripheral interface connectors of the base module.

14. The module computer system according to claim 13, wherein the power module further comprises a power plug module.

15. The module computer system according to claim 13, wherein the power module further comprises a battery power module.

16. The module computer system according to claim 13, wherein the interface connectors of the base module, the first and second computer peripheral interface connectors of the peripheral module, the computer interface connector of the host computer module, and the power interface connector of the power module each comply with a USB standard.

17. The module computer system according to claim 16, further comprising:
a base module rail segment spaced-apart from, and fixed horizontally to, the base module;
a peripheral module rail segment spaced from, and fixed horizontally to, the peripheral module;
a host computer module rail segment spaced-apart from, and fixed horizontally to, the host computer module; and
in the peripheral connecting position of the peripheral module and the computer connecting position of the host computer module, the base module rail segment cooperates with the peripheral module rail segment and the host computer module rail segment to form a peripherals-supporting rail that extends horizontally along the base, peripheral, and host computer modules.

18. The module computer system according to claim 17, further comprising:
a power module rail segment spaced-apart from, and fixed horizontally to, the power module; and
in the peripheral connecting position of the peripheral module, the computer connecting position of the host computer module, and the power connecting position of the power module, the power module rail segment relates to the base module rail segment so as to form an extension of the peripherals-supporting rail thereby forming a part of the peripherals-supporting rail.

19. The module computer system according to claim 18, wherein in the peripheral connecting position of the peripheral module, the computer connecting position of the host computer module, and the power connecting position of the power module, the base module, the peripheral module, the host computer module, and the power module cooperate to form a supporting bottom positionable against a support surface.

20. The module computer system according to claim 19, The module computer system according to claim 18, wherein in the peripheral connecting position of the peripheral module, the computer connecting position of the host computer module, and the power connecting position of the power module, the base module, the peripheral module, the host computer module, and the power module cooperate to form opposed, parallel front and rear faces, wherein the peripheral interface connectors of the base module are formed along, and accessible at, the front and rear faces.
